(19) United States
(12) Patent Application Publication
(10) Pub. No.: US 2017/0087815 A1
(43) Pub. Date: Mar. 30, 2017

(54) LINER-FREE LABEL APPLICATION

(71) Applicant: NuLabel Technologies, Inc., East Providence, RI (US)

(72) Inventors: Michael Medeiros, Plainville, MA (US); Gregory W. Johnston, Scarborough, ME (US); Juris Alex Grauds, Canton, MA (US); Andrew W. Marsella, Providence, RI (US)

(73) Assignee: NuLabel Technologies, Inc., East Providence, RI (US)

(21) Appl. No.: 15/274,375

(22) Filed: Sep. 23, 2016

Related U.S. Application Data
(60) Provisional application No. 62/232,024, filed on Sep. 24, 2015.

(51) Int. Cl. B32B 38/00; B32B 37/00; G09F 3/10; B32B 41/00

(52) U.S. Cl. CPC B32B 38/0004; B32B 41/00; B32B 37/0053; G09F 3/10; B32B 2519/00; G09F 2003/0226

(57) ABSTRACT

A system includes an applicator including at least one aperture configured to apply fluid to a back side of a label, the back side of the label including a fluid activatable adhesive; a speed detector configured to detect a speed of the label along a label path through the system; and a control system configured to control fluid application to the label based on the speed of the label. The label may be moved by two different label drives while fluid is applied to the label by the applicator, and a speed at which the label is moved by a first drive may be used to control a speed at which the label is moved by a second drive.

This application claims priority to U.S. provisional application 62/232,024, filed Sep. 24, 2015, which is hereby incorporated by reference in its entirety.

### BACKGROUND

Adhesive sheet printing and/or labeling is often performed by printing on adhesive sheets that include an adhesive agent layer that is constantly and consistently sticky. Many adhesive sheets are formed with a removable non-stick layer including both a release coat and a release liner. The removable non-stick layer is disposed over the adhesive agent layer to prevent the adhesive agent layer from coming into contact with internal components of a label printer, applicator, or labeler; and with a printable layer of an adhesive sheet when an adhesive sheet is wound in a form factor such as a roll. The removable non-stick layer can be disposed of after printing or at the time the label is applied to an article, either manually or by an automated removal process.

Some adhesive labels are formed of a sheet having a printed layer, a release coat, and an adhesive agent layer that is constantly and consistently sticky. The release coat prevents the adhesive agent layer from adhering to the printed layer. To accommodate these adhesive labels, standard printing, labeling, and label applying equipment are coated with a non-stick material to prevent the adhesive agent layer from gumming or jamming the equipment components. The printed layer is also coated with a non-stick material to resist the adhesive agent layer. Some adhesive labels include a printed layer, a sheet, and an adhesive agent layer that can be made sticky by an activator prior to or after printing/applying an image. Printing, labeling, and label applying equipment used in conjunction with these labels are also coated with a non-stick coating to avoid gumming or jamming, such as the invention disclosed in U.S. Pat. No. 6,298,894 by Nagamoto et al. that utilizes silicone oil.

### SUMMARY

In a general aspect, a system includes an applicator including at least one aperture configured to apply fluid to a back side of a label, the back side of the label including a fluid activatable adhesive; a speed detector configured to detect a speed of the label along a label path through the system; and a control system configured to control fluid application to the label based on the speed of the label. For example, one or more of a fluid flow rate through the at least one aperture, a volume of fluid applied through the at least one aperture, a timing of fluid flow through the at least one aperture, or a speed at which the label is moved during fluid application may be controlled based on the detected speed of the label.

Embodiments can include one or more of the following features.

The speed detector is configured to detect the speed of the label without physically contacting the label. The speed detector is configured to detect a pattern of markings on the back side of the label. The speed detector is configured to determine the speed of the label based on the detected pattern of markings.

The speed detector includes an encoder roller.

The system includes a printer configured to print an image or text onto the front side of the label.

The system includes a label transfer device configured to apply the label to a substrate. The label is adhered to the substrate by the fluid activatable adhesive.

The application of fluid to the back side of the label activates the fluid activatable adhesive.

In another general aspect, a system may include an applicator including at least one aperture configured to apply fluid to a back side of a label. The back side of the label may include a fluid activatable adhesive arranged so that application of the fluid to the fluid activatable adhesive activates the adhesive to make the adhesive tacky or otherwise suitable to adhere the label to a substrate. A speed detector may be configured to detect a first speed of the label along a portion of a label path of the system in which the label is attached to label stock and the applicator applies fluid to a first portion of the back side of the label. As an example, the applicator may be controlled to adjust application of the fluid, e.g., a flow rate, pressure or other parameter related to the fluid application may be set or otherwise adjusted based on the detected speed. A cutter may be arranged to cut the label from the label stock at a location upstream of the applicator. By positioning the cutter upstream of the applicator, activation fluid is not applied to the cutter and/or the cutter will not be exposed to activated adhesive which may interfere with operation of the cutter. A control system may be configured to control a second speed at which the label is moved relative to the applicator after the label is cut from the label stock and during which the applicator applies fluid to a second portion of the back side of the label based on the first speed of the label. For example, the label and associated label stock may be driven by a first label drive (such as a set of motor driven rollers) located upstream of the cutter to move the label into and at least partially through a section where fluid is applied to the label by the applicator. However, once the label is cut from the label stock by the cutter, the first label drive may not be capable of moving the label anymore. A second label drive downstream of the cutter may move the label, e.g., to move the label relative to the applicator so that the applicator can complete its operation of applying fluid to the back side of the label. The control system may control the second label drive to move the label based on the detected first speed of the label. For example, the control system may control the second label drive to move the label at a second speed that is equal to the first speed to help ensure that fluid is applied to the back side of the label in a consistent and uniform fashion. Alternately, the control system may control the second label drive to move the label at a different speed than the first speed, and control the applicator to adjust fluid application parameters (such as fluid flow rate, fluid pressure, fluid volume, etc.) to provide a consistent application of fluid or other desired fluid application result.

In one embodiment, a printer may be located upstream of the cutter and be configured to print an image or text onto the front side of the label. Such image or text information may include a barcode, shipping address, identification of goods in a package, etc. In some cases, the printer may be arranged to move the label along the label path, e.g., the printer may include a first label drive arranged to move the label and associated label stock relative to the printer, the cutter and/or applicator. The printer may control the speed of the label, e.g., to print a desired image or text on the label, and may include a speed detector to provide speed information to the control system.

In one embodiment, a label transfer device may be configured to receive the label from the cutter and apply the back side of the label to a substrate such that the fluid activatable adhesive adheres the label to the substrate. For example, with a label printed and its adhesive activated by application of fluid, the label transfer device may receive the label and apply the label to a box, envelope or other substrate. The label transfer device may include a variety of different components to receive and transfer the label to a substrate, such as robotic arm or other structure, a rotating belt, or other mechanism capable of physically moving the label from the cutter/applicator to a substrate. Thus, the label transfer device may include a second label drive arranged to move the label, after the label is cut from label stock, relative to the applicator so that the applicator can apply fluid to a portion of the back side of the label, and then apply the label to a suitable substrate.

In one embodiment, the control system may be arranged to control the label transfer device and the received label (i.e., a label received by the label transfer device) to move relative to the applicator such that the label moves at the second speed while the applicator applies fluid to the second portion of the back side of the label. For example, as described above, a printer may be able to move a label relative to the applicator so that the applicator can apply fluid to a first portion of the label, such as a leading or forward portion of the label. However, the printer may not be able to move the label sufficiently relative to the applicator so the applicator can apply fluid to the entire back side of the label, e.g., because the label is cut from label stock engaged with the printer-based label drive such that the printer label drive can no longer move the label. Alternately, the label may not be attached to label stock, but may be a separate and independent from other labels, and the printer-based label drive may be incapable of moving the label through a complete range of motion needed for the applicator to apply fluid to the entire back side of the label. In such case, the label transfer device may receive the label after the label is disengaged from the printer-based label drive and move the label through a remaining portion of the range of motion to enable the applicator to apply fluid to a second portion of the label, such as a trailing or rear portion of the label. The second speed at which the label transfer device moves the label may be the same as the first speed of the label as moved by the printer-based or other first label drive, or different.

In one embodiment, the control system controls the label transfer device to move the label in a first direction while the applicator applies fluid to the second portion of the back side of the label, and controls the label transfer device to move in a second direction different from the first direction to apply the back side of the label to the substrate. For example, the label transfer device may move the label in a horizontal direction while the applicator applies fluid to the label, and then move vertically to apply the label to a substrate.

In some cases, suction may be used to secure a front side of the label to the label transfer device. For example, the label transfer device may include a suction pad arranged as a flat plate of rubber, plastic or other suitable material that includes one or more holes through which air is drawn to create desired suction. As the label is moved toward the suction pad, the suction may draw the front side of the label so as to secure the label to the suction pad with the back side of the label exposed on a side opposite the suction pad. This may allow the suction pad and secured label to be moved into contact with, or near, the substrate to apply the label to the substrate. The suction pad and label need not contact the substrate while the label is secured to the pad to apply the label to the substrate. Instead, air or other gas flow may be applied to the front side of the label to push the label into contact with the substrate to apply the label.

In another general aspect, a system includes a first label drive arranged to move a label along a path, an applicator arranged to receive the label from the first label drive and including at least one aperture configured to apply fluid to a back side of the label where the back side of the label includes a fluid activatable adhesive, and a second label drive arranged to receive the label from the applicator and move the label relative to the applicator while the applicator applies fluid to a second portion of the back side of the label. As described above, the first label drive may be part of a printer or other component. As another option, the first label drive may be part of the applicator or activator system. For example, a label may be hand-fed into an activator that includes a set of drive rollers, a conveyor, belt or other arrangement to move the label relative to an applicator that applies fluid to the adhesive on a first portion of the back side of the label. The second label drive may be part of a label transfer device, as described above, or may be part of the activator system and move the label relative to the applicator while fluid is applied to a second portion of the back side of the label.

In some embodiments, a speed detector may be configured to detect a first speed of the label while the first label drive moves the label and the applicator applies fluid to a first portion of the back side of the label. A control system may be configured to control a second speed at which the label is moved by the second label drive relative to the applicator while the applicator applies fluid to the second portion of the back side of the label based on the first speed, e.g., the second speed may be equal to the first speed, or different.

In one embodiment, a printer may be upstream of the applicator and configured to print an image or text onto the front side of the label. The first label drive may be part of the printer, e.g., one or more rollers that engage and move the label in the printer.

In some cases, the label may be part of an elongated label stock (such as a strip of paper suitably long to form multiple labels) that is moved by the first label drive, and a cutter may be arranged to cut the label from the elongated label stock at a location upstream of the applicator after the applicator has applied fluid to the first portion of the back side of the label.

In one embodiment, a label transfer device may be configured to transfer the label to a substrate, and the second label drive may be part of the label transfer device.

In a general aspect, a system includes a label activator including at least one aperture configured to apply a fluid to a back side of a label where the back side of the label includes a fluid activatable adhesive. A label transfer device may be configured to transfer the label to a substrate such that the label adheres to the substrate with the fluid activatable adhesive. The at least one aperture of the label activator may be positioned such that fluid or air flow from the at least one aperture pushes the label toward the label transfer device.

In one embodiment, the at least one aperture of the label activator is angled relative to a vertical direction such that fluid or air flow from the at least one aperture pushes the label upwardly toward the label transfer device. In some embodiments, the label transfer device may receive the label at a second location that is vertically above a first location where the label receives fluid from the activator. In such a case, the fluid may be directed generally upwardly to urge the label toward the second location where the label is received by the label transfer device. For example, the at least one aperture of the label activator may be angled such that fluid or air flow from the at least one aperture helps keep the label in contact with a suction element on the label transfer device while the label is being moved toward the label transfer device.

In another embodiment, the at least one aperture of the label activator is arranged such that fluid or air flow from the aperture urges the label into contact with a surface of the label transfer device while the label is moved out of the label activator. The surface of the label transfer device may include a suction element arranged to secure a front side of the label to the surface.

In one embodiment, a control system may be configured to cause the label activator to apply the fluid to a first portion of the back side of the label; cause the label to be cut from a label stock; and cause the label activator to apply the fluid to a second portion of the back side of the cut label. The control system may be arranged to detect a first speed of the label while the label activator applies fluid to the first portion of the back side of the label, and arranged to move the cut label at a second speed equal to the first speed while the label activator applies fluid to the second portion of the back side of the label. In some arrangements, the label transfer device may be arranged to receive the cut label from the label activator prior to the label activator applying the fluid to the second portion of the back side of the cut label, and the control system may be arranged to control the label transfer device and the received label to move away from the label activator while the applicator applies fluid to the second portion of the back side of the label.

The approaches described here can have one or more of the following advantages. A solvent-sensitive adhesive agent layer of a solvent-sensitive adhesive sheet can become adhesive after exiting a solvent activation apparatus. Label printers, label applicators, and other labeling equipment connected physically and electronically to the present invention do not require a non-stick material coating of internal printer or other equipment components to prevent adhesive exposure, because a solvent-sensitive adhesive may not be rendered tacky until it passes through an activation site where activation fluid is applied to the adhesive. By enabling label printers and other label handling equipment to support a solvent-sensitive adhesive sheet, adhesive sheets with a release liner and the need to coat components and adhesive sheets with a non-stick material are no longer necessary. And further, in certain instances, the solvent-sensitive adhesive agent layer may be rendered tacky without connecting the solvent activation apparatus electronically or physically to a printer or other equipment.

Other features and advantages are apparent from the following description and from the claims.

### BRIEF DESCRIPTION OF DRAWINGS

FIG. 1 is a schematic system diagram of a liner-free label activator.

FIG. 2 is a schematic perspective view of a liner-free label activator, a printer, and a reservoir.

FIG. 3A is a schematic perspective view of a housing.

FIG. 3B is a schematic perspective view of a printer representation with an interface for the housing depicted in FIG. 3A.

FIG. 3C is a schematic perspective view of the housing depicted in FIG. 3A and the printer representation depicted in FIG. 3B coupled together.

FIGS. 4A-4E are schematic views of components of the liner-free label activator depicted in FIG. 1.

FIG. 5 is a schematic isometric transparent view of a pressurization chamber.

FIG. 6 is a schematic isometric transparent view of a pressure sensor.

FIG. 7 is a flowchart of the operation of the liner-free label activator depicted in FIGS. 4A-4E.

FIGS. 8A and 8B are schematic isometric views of a standalone liner-free label activator.

FIG. 9 is a schematic perspective partial view of an activator assembly attached to a printer.

FIG. 10 is a schematic sectional view of the activator assembly depicted in FIG. 9.

FIGS. 11A and 11B are schematic plan views of a pair of distribution doors in an open and a shut position in accordance with the activator assembly depicted in FIG. 9.

FIG. 12 is a schematic transparent isometric view of a gear assembly in the activator depicted in FIG. 9.

FIGS. 13A and 13B are front and rear schematic isometric views of an activator assembly.

FIG. 14 is a schematic front transparent isometric view of the activator assembly depicted in FIGS. 13A and 13B.

FIG. 15A is a schematic sectional view of an activator assembly.

FIG. 15B is a schematic sectional view of the activator assembly depicted in FIG. 15A activating a label.

FIGS. 16A and 16B are schematic side views of a label printing and application system.

FIG. 17 is a schematic view of a label.

### DETAILED DESCRIPTION

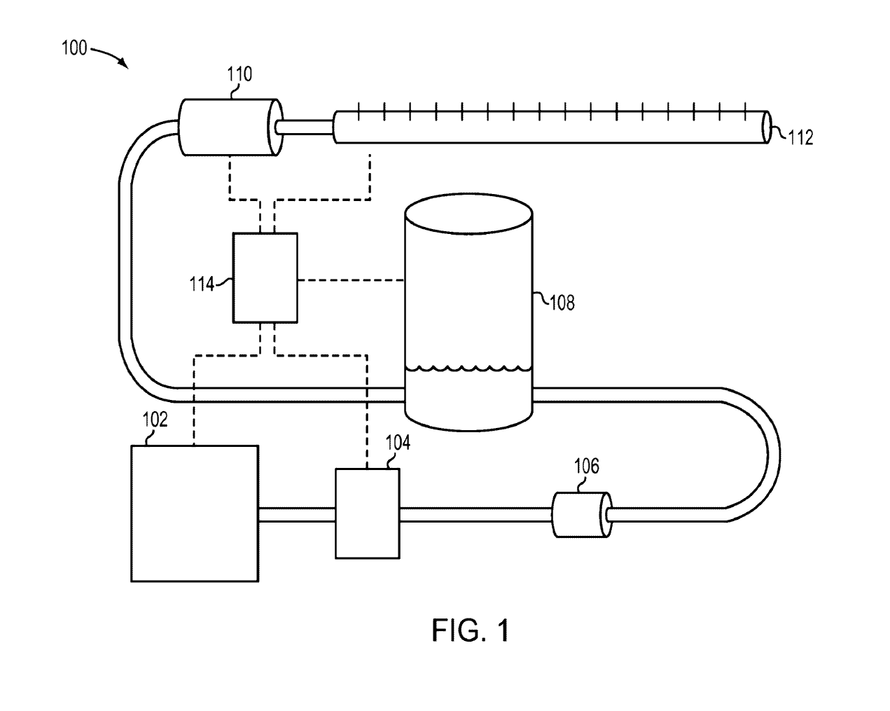

FIG. 1 depicts a system level view of a liner-free label activator 100. The activator 100 includes a reservoir/cartridge 102, a pump 104, a check valve 106, a pressurization chamber 108, a liquid valve 110, an applicator 112, and an activator control system 114. Each component within the activator 100 is fluidically coupled to at least one other component (except for the activator control system 114) as depicted in FIG. 1. The fluidic connections may be made through any conduit suitable for transporting fluid and allowing for sealed connections at each end, such as flexible tubing or channels formed or machined in other structures, such as an activator housing. Stainless steel tubing (or other rust resistant and rigid materials such as high density polyethylene (HDPE), other hard plastics, certain other metals, etc.) may also be utilized, and lowers the risk of unintended pressure changes because the shape remains constant. The activator control system 114 may be in electronic communication with one or any combination of the following components and/or associated sensors: the pump 104, the pressurization chamber 108, the liquid valve 110, the reservoir 102, and the applicator 112. The particular structure and function of these components will be explained in greater detail below.

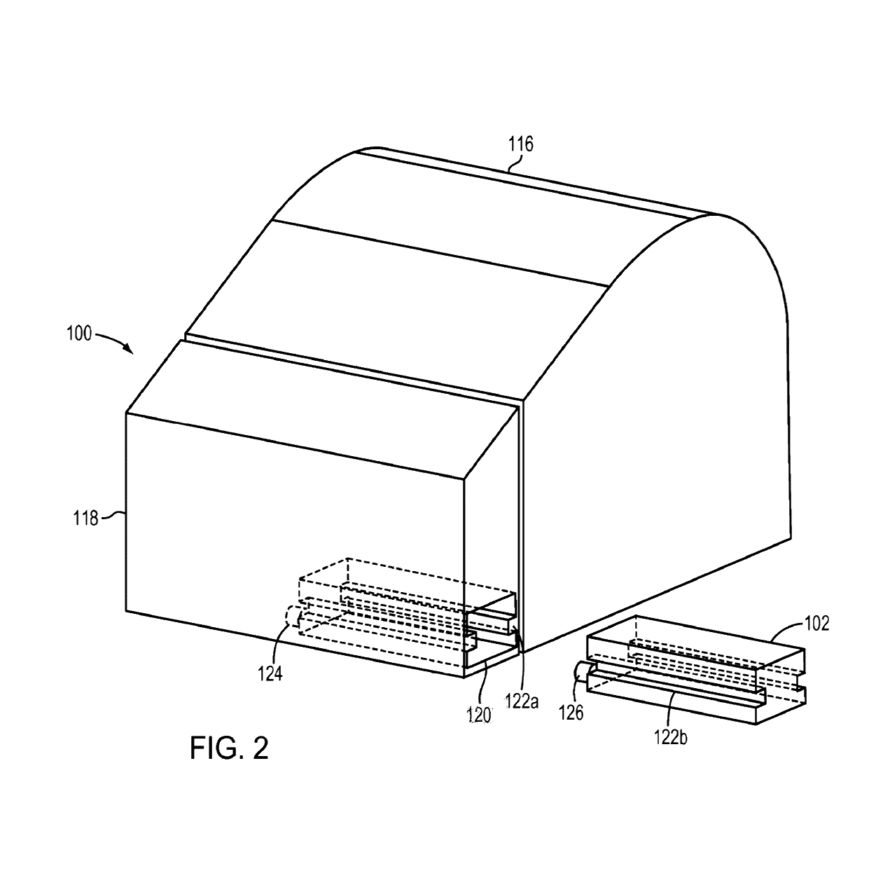

FIG. 2 depicts one embodiment of the liner-free label activator 100 coupled to a printer 116, such as a thermal printer, ink jet printer, laser printer, etc. The activator 100 includes a housing 118 and the reservoir/cartridge 102. Additional components of the activator 100 are depicted in subsequent figures. The activator 100 may be connected to other non-printer equipment, such as a downstream label applicator and/or an upstream label feed system. The other equipment may provide power, control signals, and/or label feed systems similar to those that may be provided by a printer and suitable for interconnection with the activator 100.

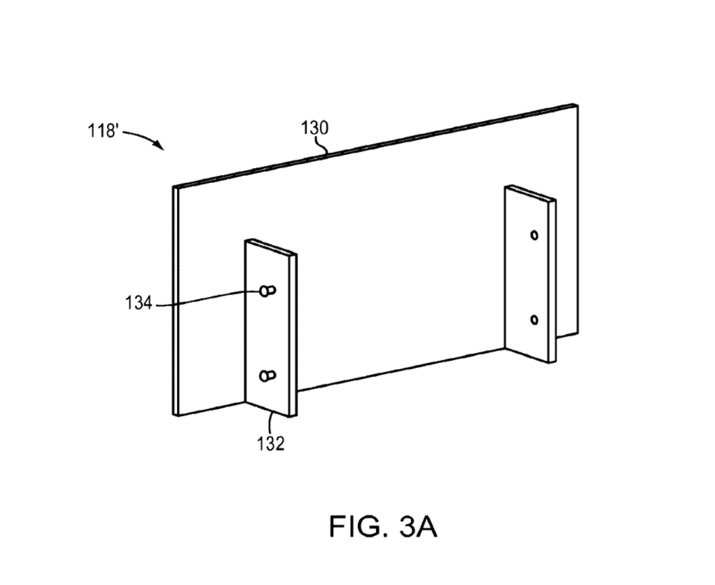

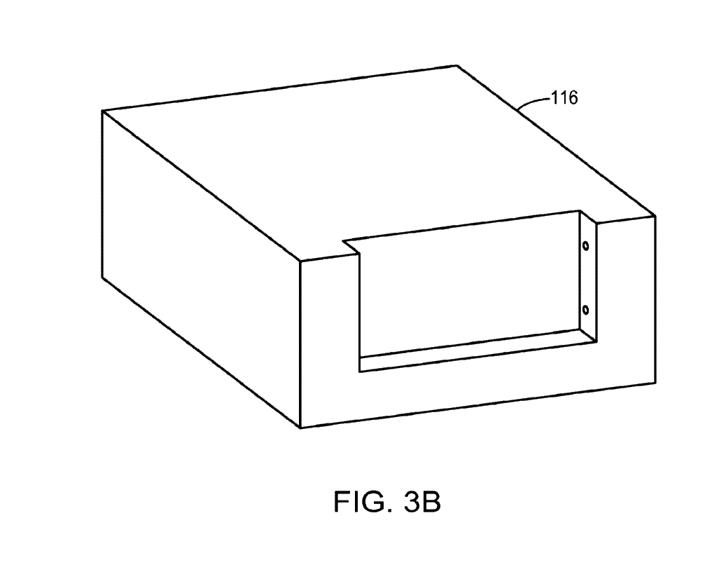

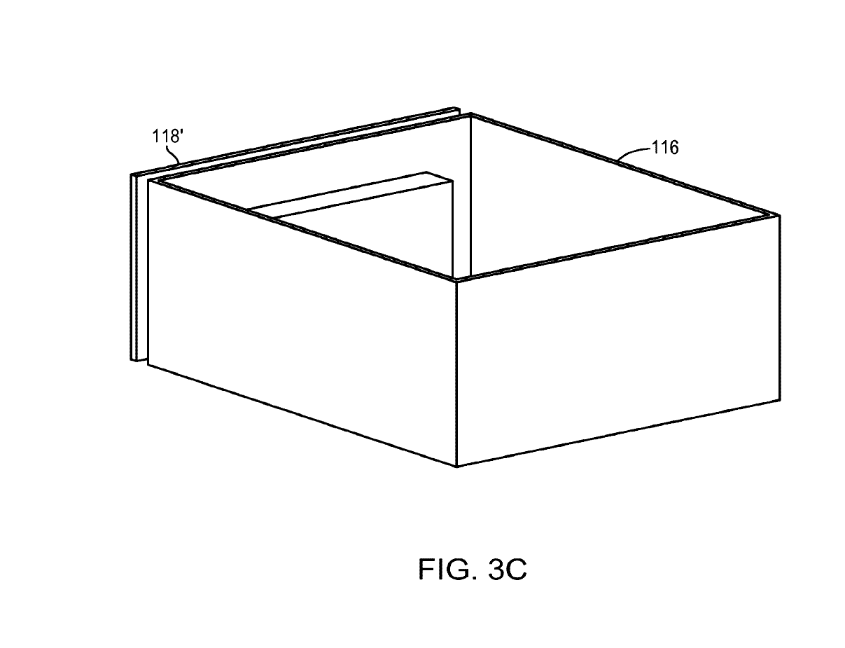

The housing 118 may be mounted to the printer 116, so that a label exiting the printer 116 follows a label path into the housing 118. The housing 118 may be formed to complement the form and/or contour of the printer 116, so as to resemble a natural extension of the printer 116. The housing 118 may define an enclosed space, as depicted in FIG. 2, but may also be any form configured to allow attachment of the activator components to a surface thereof, such as a housing 118′ depicted as a wall in FIG. 3A.

In this embodiment, a portion of the housing 118 forms a chamber for receiving the cartridge 102. The chamber defines a dock 120. The dock 120 is configured to hold securely the cartridge 102, with particular mating surfaces and an integral fluidic connection or port. The dock 120 may include one or more sliding surfaces, such as a tongue and groove system, wherein one or more tongues 122a are disposed on sides of the dock 120 and mating grooves 122b are formed in sides of the cartridge 102. The tongues 122a and the grooves 122b are closely dimensioned, so as to provide a close sliding fit. Alternative registration and/or fastening methods may be implemented, such as a clip, a threaded connection, a latch, a magnet, or any other fastening means suitable for the application. Fastening helps ensure that the cartridge 102 will stay securely seated within the dock 120 even if the activator 100 is dropped, tumbled, or otherwise jarred.

The dock 120 includes an inlet 124 configured to interface closely with a cartridge outlet 126 to create a fluidic seal between the cartridge 102 and the dock 120. When the cartridge 102 is firmly seated in the dock 120, an activation fluid in the cartridge 102 may be pumped to other components within the activator 100 without leaks, drips, or other losses.

The cartridge 102 is configured to hold an activation solvent and may be any shape or size configured to contain a fluid and to mate with the dock 120. In another embodiment, the cartridge 102 and the dock 120 are replaced by a reservoir either permanently installed in or formed integrally with the housing 118. Additional forms of the cartridge 102 may be dictated by transportation considerations by, for example, dimensioning the cartridge 102 to fit within the negative space in the middle of a roll of labels, so the cartridge and labels can be efficiently packaged and sold as a consumable set or kit. Each cartridge 102 may be dimensioned to contain a volume of an activation solvent to activate fully at least one roll of associated labels. This allows for a convenient way for an end user to resupply the activator 100 with an accurate and repeatable volume of activation solvent, as needed. The cartridge 102 may be positioned anywhere on the housing 118, as long as it is in fluidic contact with the pump 104 (discussed below).

FIGS. 3A-3C depict one embodiment of the connection between the housing 118′ and the printer 116. The housing 118′ includes a large wall portion 130 with two smaller wall portions 132 or flanges substantially extending perpendicularly from the large wall portion 130. The small wall portions 132 include a coupling structure 134 for connecting the housing 118′ to the printer 116. In one embodiment, the coupling 134 may be mounting screws designed to interface with machined holes in the smaller wall portions 134 and in a recess of the printer 116. Several additional fastening means capable of securing the housing 118′ to the printer 116 may be used, including semi-permanent fasteners (e.g., nuts and bolts, rivets, etc.) and quick disconnects (e.g., clamps, spring loaded ball-bearings, pin connections, etc.).

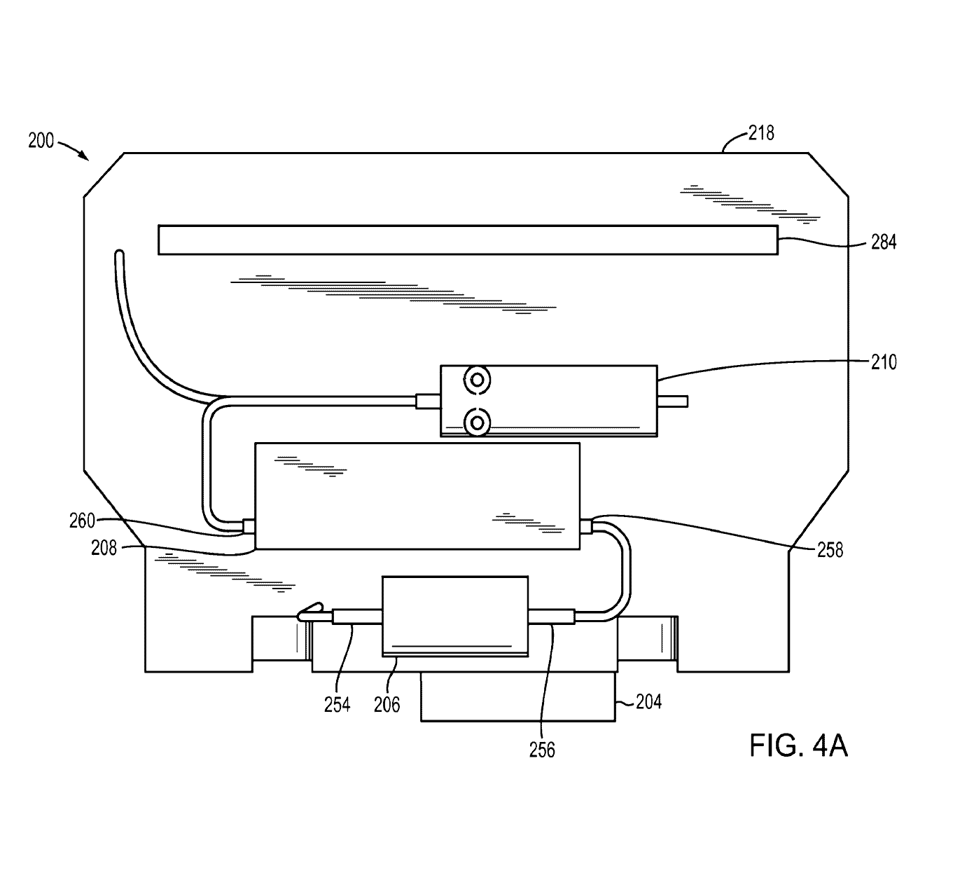

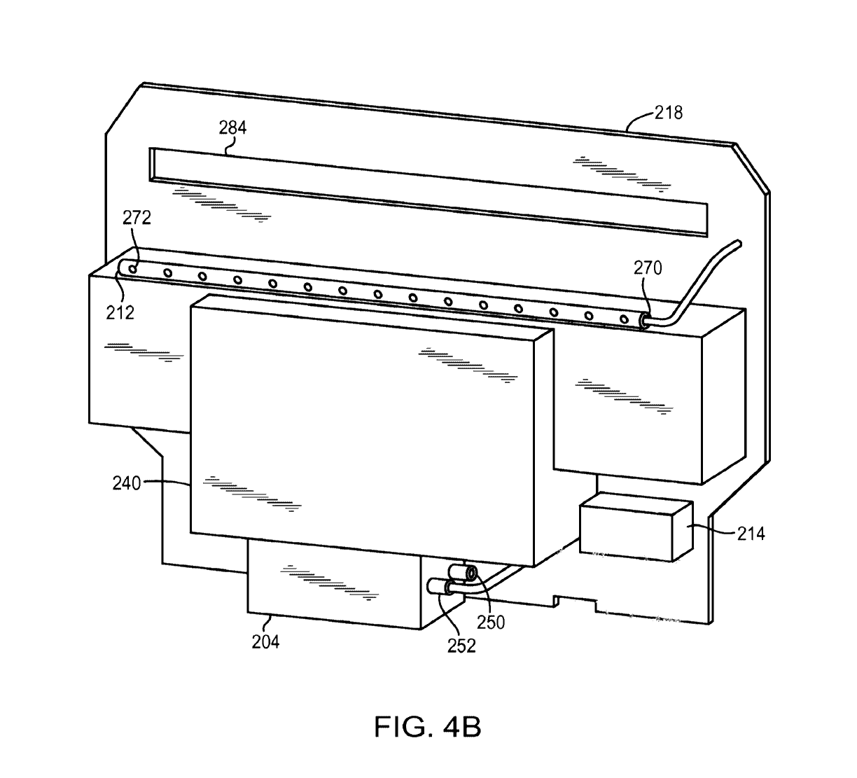

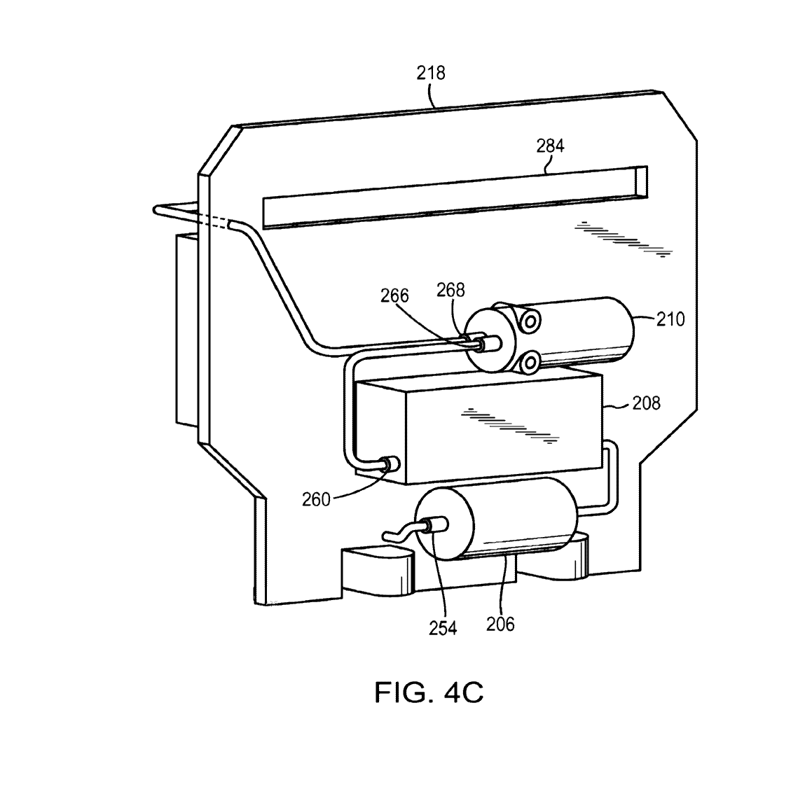

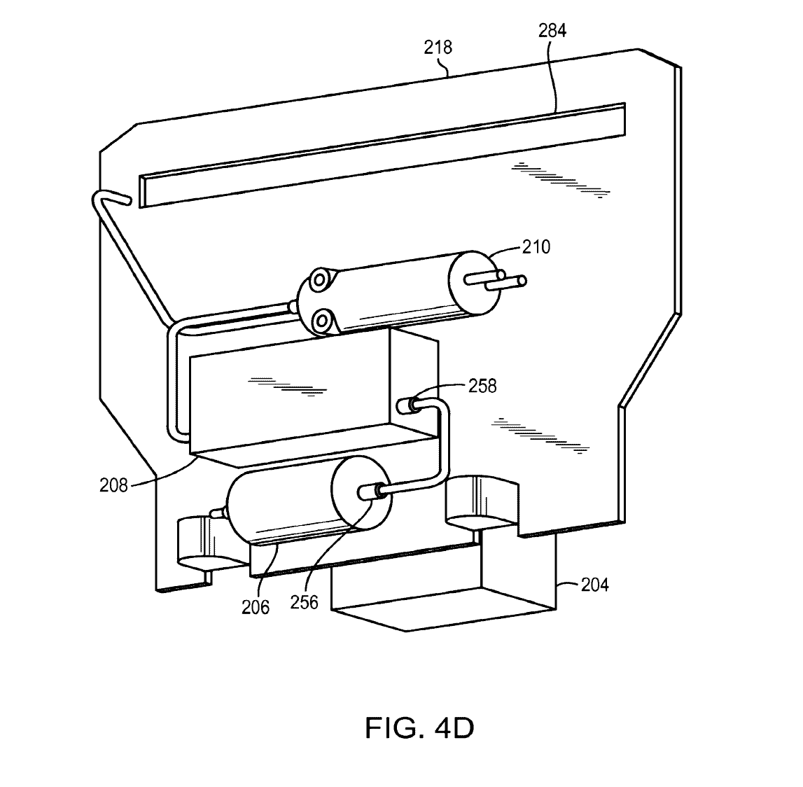

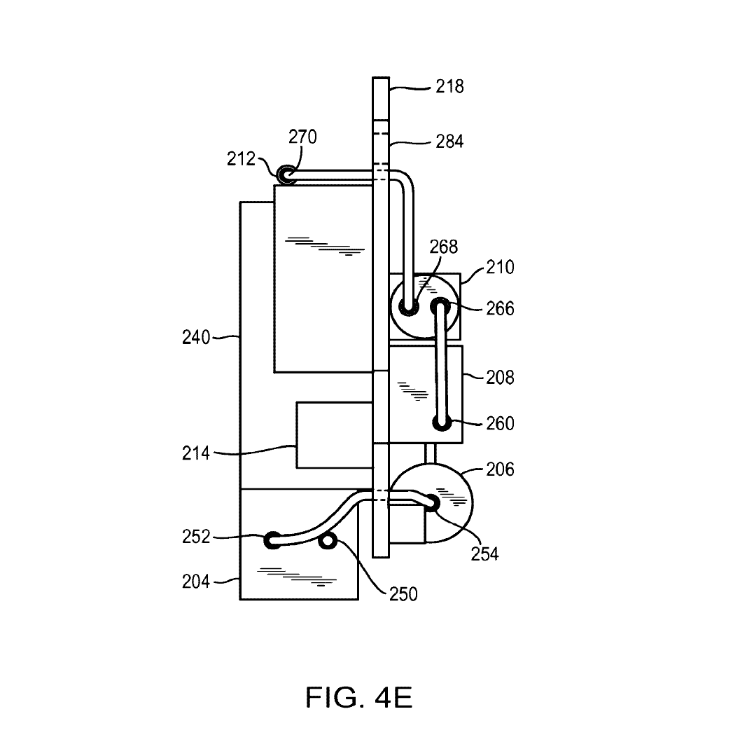

FIGS. 4A-4E depict one embodiment of a liner-free label activator 200, based on a wall-mounted component concept. The liner-free label activator 200 includes a housing 218, a reservoir (not shown), a pump 204, an applicator 212, and an activator control system 214. Additional features are also depicted, including a liquid valve 210, a check valve 206, a pressurization chamber 208, and a cutting mechanism 240.

The housing 218 is similar to the housing 118′ depicted in FIG. 3A, though without the mounting flanges. The housing 218 is configured to allow each component to be attached to a side thereof. The components may be attached to the housing 218 via fasteners, such as screws, rivets, or other attachment means. Alternative forms for the housing 218 are discussed above, such as an enclosure, as depicted in FIG. 2. The housing defines a label slot 284 configured to accept a label moving therethrough. The label slot 284 may be located above where the applicator 212 is mounted to the housing 218, and may be positioned such that a label passes through the label slot 284 prior to being activated and no sticky part of a label contacts the label slot 284.

The pump 204 is fluidically coupled to a reservoir (e.g., a cartridge) via a pump inlet 250. The pump 204 is used to pressurize an activation solvent in the activator 200 and to create suction to draw activation solvent out of the reservoir. The pump 204 can be one of many different kinds of pumps, including a positive displacement pump. Positive displacement pumps have an ability to self-prime and can keep flowing, whether the pressurized medium is liquid or gas. Centrifugal pumps may be used, though they generally utilize a specific priming sequence, more power, and will stop running if gas is present in the line. Any pump that has the ability to self-prime, or has a mechanism in place to eliminate priming problems, may be preferable, although any pump could be used. Additionally, the pump should be able to maintain a certain pressure at a given flow rate. As flow rate is a function of an activation solvent coat thickness, label speed, and label width, different applications will have different requirements. Flow rate can be calculated using the equation:

Flow Rate (mL/min)=[Thickness (mils)*Label Speed (in/sec)*Label Width (in)*60 sec/min]/[0.06102 in³/mL*1000 mils/in.]

Flow rates between about 100 mL/min (0.75 mils, 15 in/sec, 9 in) and about 0.14 mL/min (0.15 mils, 2 in/sec, 0.5 in) are anticipated based on typical industry parameters, however a wider range of flow rates may be handled. Determining an appropriate pressure for different flow rates is difficult, though pressure requirements can be estimated with the following equation:

Pressure (psi)=0.136*Flow Rate (mL/min)+1.93

Based on this equation, a pressure of around 15 psi would support an anticipated high flow rate and a pressure of around 1.9 psi would support an anticipated low flow rate.

The check valve 206 is fluidically coupled to the pump 204 via a pump outlet 252 and a check valve inlet 254. The check valve 206 can be one of many different types, such as the #301 check valve from Smart Products (Morgan Hill, Calif.), capable of allowing flow in only one direction, downstream from the reservoir and the pump 204. In another embodiment, the check valve 206 may be an insert within flexible tubing, such as a flow control from The Lee Company (Westbrook, Conn.), which may be smaller than the previously described check valves.

The pressurization chamber 208 is fluidically coupled to the check valve 206 via a check valve outlet 256 and a pressurization chamber inlet 258. The pressurization chamber 208 maintains pressure within the activator 200 for instantaneous activation, so that the pump 204 need not be operating at full pressure or full time, since the pump 204 must ramp up to and down from operating pressure as it is turned on and off. In contrast, pressurized fluid maintained in the pressurization chamber 208 may be used, as desired.

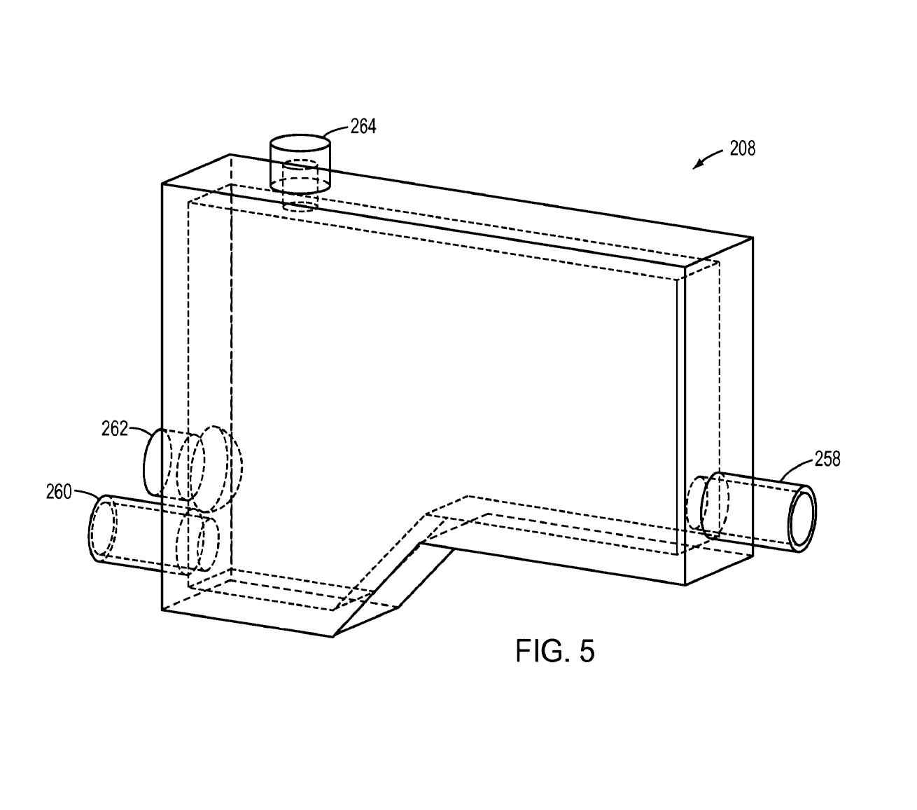

One embodiment of the pressurization chamber 208 is depicted in FIG. 5. The pressurization chamber 208 may be substantially rectangular and oriented in an upright position, for compactness. The pressurization chamber 208 in this embodiment may be configured to hold a fluid volume in a lower portion and a variable gaseous volume in an upper portion. The pressurization chamber inlet 258 is disposed on one side of the pressurization chamber 208. A pressurization chamber outlet 260 is disposed on an opposite side of the pressurization chamber 208 from the pressurization chamber inlet 258. The pressurization chamber outlet 260 is also disposed at a lower level than the pressurization chamber inlet 258 to promote fluid flow out of the pressurization chamber 208. A fluid sensor 262 may be disposed above the pressurization chamber outlet 260 to detect if the fluid volume falls below a certain level. An air valve 264 is disposed on a top side of the pressurization chamber 208 and can open automatically, to release excess air volume in the system.

When the liquid valve 210 upstream of the applicator 212 is closed, fluid that is pumped into the pressurization chamber 208 increases the fluid volume within the pressurization chamber 208, raising the pressure of air within the pressurization chamber 208 by compressing the gaseous volume. Once the liquid valve 210 is opened, the pressurized gaseous volume pushes against all surfaces in attempting to regain its equilibrium volume, forcing fluid out of the pressurization chamber outlet 260 to the applicator 212. If system pressure and/or fluid level in the chamber 208 falls below a predetermined value, the control system 214 turns on the pump 204 to refill the chamber 208.

An alternative embodiment of a pressurization chamber can include a length of tubing or other structure with an elastic wall. As pressure builds within the tubing, the elasticity of the wall allows it to stretch to a greater diameter. Once a valve is opened, fluid is driven by the contraction of the tubing to its equilibrium diameter. In another embodiment, a pressurization chamber includes a vertical column of fluid which is raised when fluid is added and a liquid valve is closed, increasing the stored potential energy in the column of fluid. When the liquid valve is opened, the increased potential energy provides sufficient flow to temporarily operate an applicator.

The liquid valve 210 in the depicted embodiment is fluidically coupled to the pressurization chamber 208 via a liquid valve inlet 266 and the pressurization chamber outlet 260. The liquid valve 210 regulates when fluid is sent to the applicator 212 from the pressurization chamber 208. In one embodiment, the liquid valve 210 is a normally-closed solenoid valve, though any valve that is capable of controlling a flow of fluid may be used (e.g., a pinch valve designed to selectively obstruct a length of flexible tubing). In embodiments of the activator 200 where the liquid valve 210 is used, the state of the liquid valve 210 (open or closed) dictates whether the activator 200 is operating (for instance, operating when open, not operating when closed).

The applicator 212 is fluidically coupled to the liquid valve 210 via a liquid valve outlet 268 and an applicator inlet 270. In one embodiment, the applicator 212 is substantially cylindrical with a series of small, uniformly spaced discharge apertures 272 (e.g., a spray bar). The applicator 212 may be basically any shape that allows for at least one discharge aperture 272 to be aimed at an activation site, though it may have a tapered cross-sectional area or varying aperture sizes to produce a uniform spray pattern on the adhesive layer of the label passing thereby. The applicator 212 is located near the activation site of a label path where a label will pass through and be sprayed with solvent. The discharge apertures 272 act as nozzles by taking a relatively large, slow volume of flowing liquid and transforming it into faster, more focused flows (for instance, liquid jets). The discharge apertures 272 are closely located to the activation site, close enough to produce a focused and accurate liquid jet but far enough away to avoid physical contact with a label and to allow a spray pattern to develop. Alternative embodiments use a single aperture nozzle to jet a pressurized activation solvent onto the activation site, typically in a flat fan pattern.

The discharge apertures 272 are the components that ultimately govern the flow rate, which in turn dictates a desired activation solvent coat thickness on a label. Solvent coat thickness can be determined using the following equation:

Thickness (mils)=[Flow Rate (mL/min)*0.06102 in³/mL*1000 mils/in]/[Label Speed (in/sec)*Label Width (in)*60 sec/min]

As seen in the equation, the thickness is directly influenced by the flow rate, label speed, and label width. Both label speed and label width are determined by the label printer or other equipment upstream of the activator. Each of these variables may be fixed for each individual printer, label dispenser, etc., or they can vary. Assuming a fixed installation, this leaves the flow rate as the remaining variable in achieving the desired coat thickness. We can look further into the flow rate by relating the flow rate to the diameter of the nozzles and the number of nozzles in the manifold of the applicator 212, using the following equation:

Flow_{new}=Flow_{old}*(#Nozzles_{new}/#Nozzles_{old})*(Diam_{new}²/Diam_{old}²)

This equation relates a known configuration (noted “old”) to an idealized prediction (noted “new”). Experimental data collected using a nozzle manifold with 20 nozzles that are 42 microns in diameter revealed that the nozzle produced a flow rate of 9.733 mL/min. From this information, an equation for a new expected flow rate is:

Flow_{new} (mL/min)=9.733 (mL/min)/[20*42² (μ)]*#Nozzles_{new}*Diam_{new}² (μ)

This equation assumes that the pressure within the system is constant. However, the system pressure has a dynamic relationship with the nozzle area (for instance, if nozzle area increases, pressure drops since more is lost through larger nozzles, etc.). The equation still provides some useful approximations.

A series of nozzles were selected to conduct experimental tests on flow rate, pressure, jet quality, etc. based on the above equations. While solvent thicknesses between about 0.3 and 0.5 mils are typical, this range can be extended to between about 0.15 and 0.75 mils, or even further. The coat thickness influences the adhesive quality of the activated label, and can be varied to cater to different application requirements on corrugated cardboard or other substrates to which the labels are applied. This range can be further extended to meet the needs of labels in areas outside corrugated cardboard shipping labels, such as labels used on glass bottles.

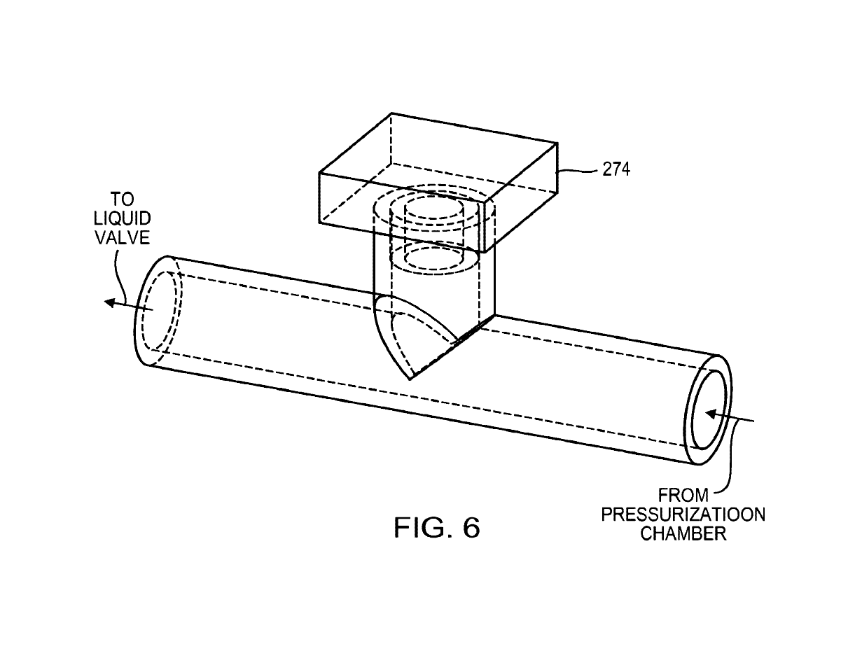

A control system 214 is provided to control or to monitor some or all of: the pump 204, the air valve 264, the liquid valve 210, the reservoir 202, the applicator 212, and related system sensors. The control system 214 controls when the pump 204 is in operation based on a pressure in the pressurization chamber 208. A pressure sensor 274, as depicted in FIG. 6, may be utilized to determine the pressure within the pressurization chamber 208. In one embodiment, the pressure sensor 274 may be placed in a “T” in a connection between the pressurization chamber 208 and the liquid valve 210 to monitor the pressure at that point in the system. The control system 214 compares the actual pressure with a preset operational pressure range and initiates the pump 204 if the pressure is too low. It then deactivates the pump 204 when system pressure exceeds the upper end of the pressure range. In other embodiments, the fluid sensor 262 may be used to control pump 204 operation, alone or in conjunction with the pressure sensor 274. If the fluid sensor 262 detects the fluid volume is too low, the control system 214 can in turn activate the pump 204 to raise the fluid volume. In another embodiment, a sensor may be placed in the gaseous volume of the pressurization chamber 208. If the gaseous volume is too large or the gaseous pressure is too low, the control system 214 can again activate the pump 204 to operate until a desired pressure or volume is reached.

The air valve 264 can also be controlled, either manually, passively, or automatically by the control system 214, to adjust the gaseous volume in the pressurization chamber 208. Additional gas may be inadvertently introduced into the pressurization chamber 208 whenever a solvent cartridge is replaced. If the gaseous volume is too great, the pressurization chamber 208 may stop working properly (e.g., the pump 204 may cycle too frequently). In one embodiment, the fluid sensor 262 may be used to detect the level of the fluid volume in the pressurization chamber 208. If the fluid volume is too low, even when system pressure is within range, the fluid sensor 262 may send a signal to the control system 214 to open the air valve 264 until the fluid volume is restored to a desired level, at which time the air valve 264 would close. Alternatively, a user could be directed to manually open the valve and bleed air from the system, for example by illumination of an error light, display of an error code or message, etc.

The liquid valve 210 is controlled to permit and prevent flow to the applicator 212 and, accordingly, allow and disallow activation. The liquid valve 210 should be opened whenever a label to be made sticky is present in the activation zone and then closed once a label has been rendered tacky. In one embodiment, a signal to begin activation can be based on a signal from the upstream equipment. In the case of a printer, there is an electronic connection between the control system 214 and an electronic control system of the printer. The control system 214 can process a signal from the printer control system indicating that a label is at a specific location along the label path. The control system 214 may then signal the liquid valve 210 to open after a known delay for a label to move from its location in the printer label path to the activation zone, also compensating for a known delay between opening the liquid valve 210 and initiation of spraying at the activation site. The control system 214 may also signal the liquid valve 210 to close at some time increment after opening based on a length and speed of a label passing through the activation zone. In alternative embodiments, one or more sensors may be used at the activation site to determine the presence of a label (or the passing of the end of a variable length label), thereby decreasing or eliminating the need to calculate the delay that must be implemented by the control system 214. In other alternative embodiments, one or more sensors may be used to monitor a physical action upstream such as a rotation of the platen motor or a firing of the printer's cutter, amongst other components.

In embodiments of the activator 200 where the reservoir is a cartridge, the cartridge can be mechanically and/or electrically linked to the dock 120 and the control system 214 to monitor a level of fluid within the cartridge. In other embodiments, with or without a cartridge, a liquid level sensor within the reservoir may be used. Alternatively or additionally, a flow meter outside of the reservoir may be used to monitor the amount of fluid that has flowed from the reservoir. When the fluid level in the reservoir is determined to be low, the control system 214 may signal the user through some audio and/or visual interface, such as a siren buzzer or LED, that the reservoir is running low on fluid.

To ensure substantially instantaneous delivery of fluid at the activation site, the applicator 212 may include a sensor to detect if a sufficient level of fluid is present in the applicator 212 to spray the activation site. If there is not sufficient fluid, the control system 214 can open the liquid valve 210 for a short period of time to fill the applicator 212.

A cutting mechanism 240 may be used with uncut label stock or other media. The cutting mechanism 240 is disposed along the label path, typically before the activation site in the applicator 212. Media passes through the cutting mechanism 240, is cut prior to entering the activation site, and then passes over the applicator 212 where it may be activated. The cutting mechanism 240 may be controlled by the control system 214 to sever the media at any desired size. By cutting the media prior to activation, the cutting mechanism 240 is at less risk of gumming or other adverse effects of unintended adhesive exposure. In one embodiment, the cutting mechanism is a four inch type “L” cutter from Hengstler (Aldinger, Germany).

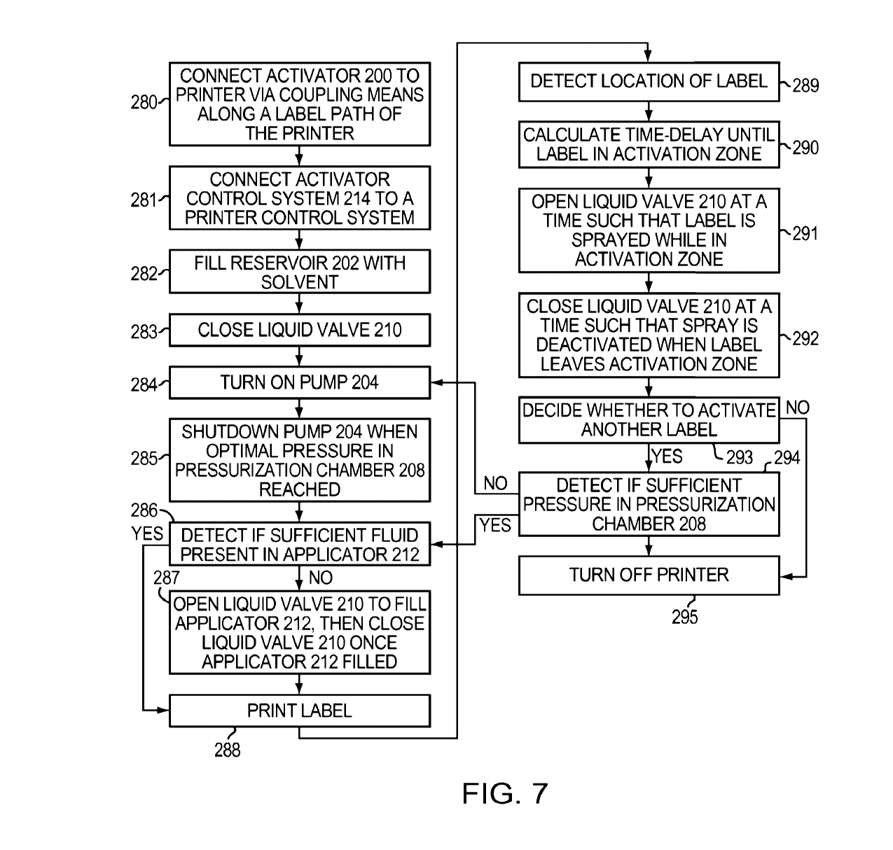

FIG. 7 depicts a flowchart detailing one method for operating the liner-free label activator 200. First, the activator 200 is connected physically to a printer or other equipment with any suitable coupling along a label path of the printer (280). Then, the activator control system 214 is connected to a printer control system (281). The physical and electrical connection can occur simultaneously. The reservoir 202 may be pre-filled or filled with solvent (282) or the cartridge may be installed or previously installed. The liquid valve 210 is closed at this point (283). The pump 204 can be turned on (284) to initially pressurize the fluidic system and then shut down, such as once an optimal pressure in the pressurization chamber 208 is reached (285). Next, the control system 214 detects if a sufficient amount of fluid is present in the applicator 212 (286). If there is not a sufficient amount of fluid, the liquid valve 210 is opened to fill the applicator 212, then the liquid valve 210 is closed once the applicator 212 is filled (287). When a label is printed (288), a location of the label is detected (289) and a time-delay until a label is in the activation zone is calculated (290). The liquid valve 210 is opened at an appropriate time at the end of the delay, so that a leading edge of the label is sprayed as soon as it enters the activation zone (291). The liquid valve 210 is closed to discontinue the spray as soon as a trailing edge of the label leaves the activation zone (step 292). Then, the control system 214 decides whether to activate another label (step 293). If another label is being printed or arriving along the label path, the control system 214 detects if there is sufficient pressure (294) in the pressurization chamber 208. If there is not sufficient pressure, the pump is turned on (284) and the process is resumed from that point. If there is sufficient pressure, the control system 214 detects if there is sufficient fluid in the applicator 212 (286) and the process resumes from there. If another label is not being printed or arriving along the label path, the printer may be turned off (295), as well as the activator.

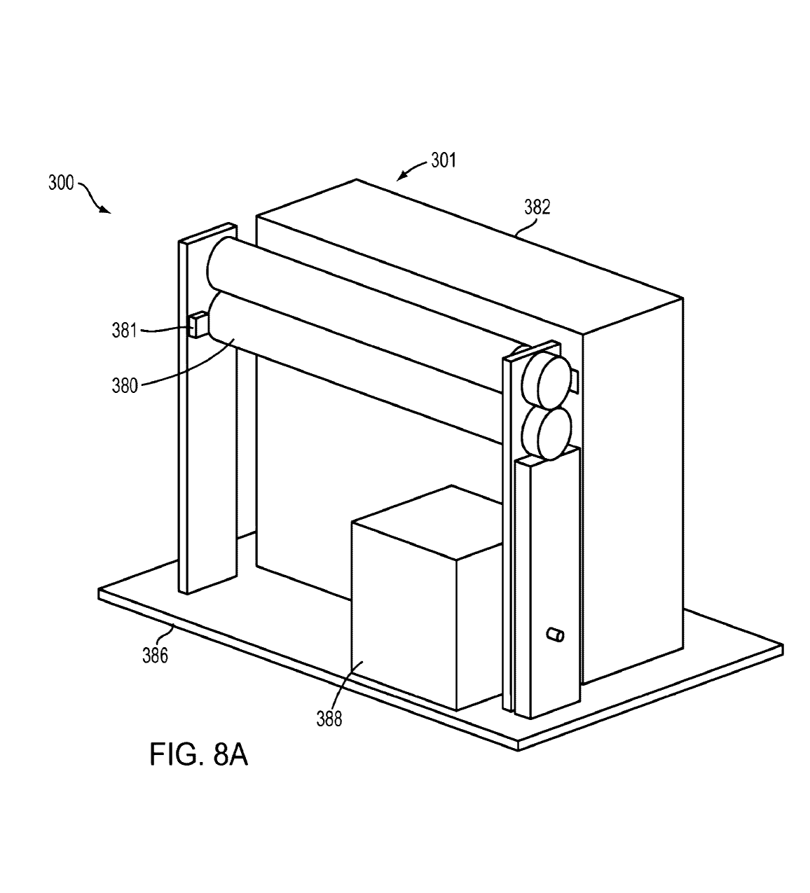

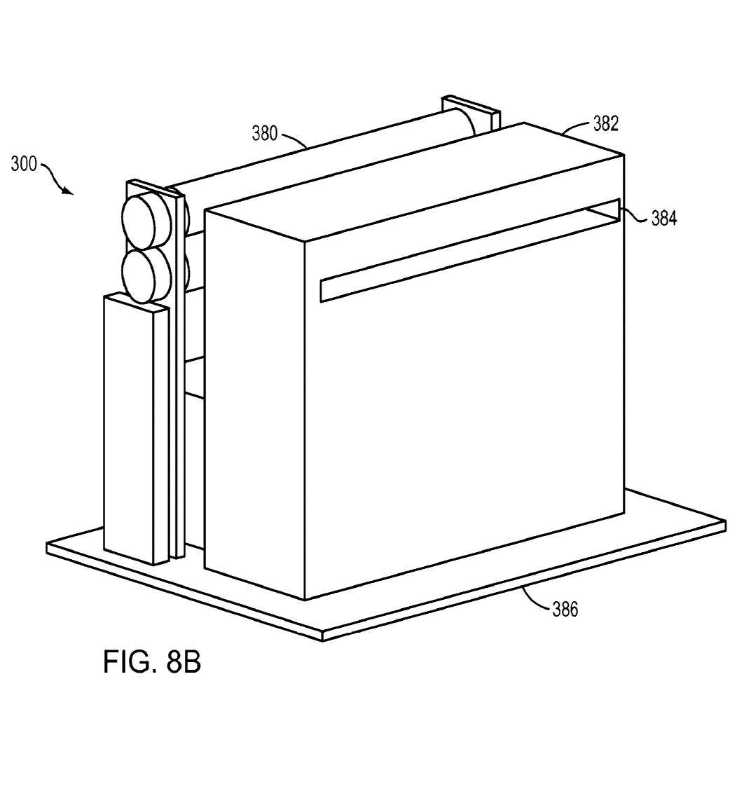

FIGS. 8A and 8B depict a standalone liner-free label activator 300. The standalone liner-free label activator 300 includes an activator subassembly 301 and a mechanical or other system 380 for moving a label.

The activator subassembly 301 typically includes many of the components previously described, including a housing, a reservoir, a pump, an applicator, and an activator control system. Other previously described components, such as a check valve, a pressurization chamber, a liquid valve, and a cutting mechanism, may also be included in the activator subassembly 301. In one embodiment, the activator subassembly 301 may be encased in a cover 382. In one embodiment, the cover 382 may be substantially rectangular, though any shape suitable to cover the components may be used. The cover 382 forms a label slot 384. The label slot 384 is configured to accept a label moving there through, and also defines an activation site where a label is activated. In one embodiment, the activator subassembly 301 is mounted to a weighted baseplate 386 for stability.

Components of the activator subassembly 301 such as the activator control system that rely upon a printer or other upstream equipment for control signals or other information, must instead obtain relevant information from within the activator 300. In one embodiment, an optical sensor 381 is used to determine when a label is in the activation site. The optical sensor 381 can be placed immediately before or after the system 380. Alternatively, a more complex system mapping the size and location of a label within the system may be used to determine when the applicator should be operating.

The system 380 for moving the label may also be mounted to the baseplate 386 or can be attached to or integrated within the cover 382. The label moving system 380 is configured to accept a label and move it through the activator subassembly 301 and dispense the activated label out the slot 384. By placing the system 380 upstream of the activator subassembly 301, the system 380 is not exposed to activated adhesive. A prime mover of the system 380 can be a motor 388. A power connection may also be provided to connect to a power source to power the motor 388 and the activator subsystem 301. The power connection may be any of a variety of forms, though a typical power connection in the US could include a 12V DC adapter that converts the 120V AC current from a standard wall outlet. In one embodiment, the label moving system 380 is a pair of gear or friction drive pinch rollers. The pinch rollers are aligned with the label slot 384 to move a label through the label slot 384 without the label contacting any of the edges of the cover 382. In another embodiment, structure similar to a platen roller and a stationary print head in a printer may be used to feed a label forward and backward through the system. The system 380 may operate at any speed that allows for consistent and sufficient activation of a label.

Methods of manufacturing a liner-free label are described in U.S. Pat. No. 8,334,336, U.S. Pat. No. 8,334,335, U.S. Pat. No. 8,716,372, U.S. Pat. No. 8,716,389, U.S. Pat. No. 8,840,994, U.S. Pat. No. 9,051,495 and U.S. Pat. No. 9,109,144, the contents of all of which are incorporated herein by reference.

### EXAMPLE

A series of solvent-sensitive adhesive liner-free labels 490 were prepared in accordance with the teachings above and the following detailed description to test adhesion properties. All test samples were conditioned at 73±3° F. and 50±5% relative humidity for at least 24 hours prior to testing. In accordance with the embodiment(s) described above, the solvent-sensitive adhesive agent layer 496 was coated on 77 gram per square meter thermal paper. Each sample's solvent-sensitive adhesive agent layer 496 was both (1) prepared with a unique dry solids percentage but within the preferred dry solids percentage range described above, and (2) coated using a different coating method from the list of preferred coating methods described above.

A first sample (Sample 1) was coated with a liquid solution containing 18% solids using a gravure method with a 24TH Gravure Cylinder as the coating instrument. A second sample (Sample 2) was coated with a liquid solution containing 22% solids using a knife over roll method. A third sample (Sample 3) was coated with a liquid solution containing 20% solids using a modified knife over roll method.

The samples were cut to one inch wide strips as required by the test methods. These results are summarized in Tables 1, 2, and 3. Tables 1 and 2 represent the results of peel adhesion tests. Peel adhesion was tested according to a modified ASTM D 3330 method F. The modification included testing at a dwell time of sixty seconds and a dwell time of sixty minutes. Dwell time is the amount of time the activated label is in contact with a substrate. Dwell time does not incorporate the elapsed time between activation and application to a substrate.

Samples of the solvent-sensitive adhesive agent layer 496 of the solvent-sensitive adhesive liner-free labels 490 were activated by de-ionized water sprayed from a hand controlled spray nozzle just prior to application. Per the testing protocol, samples were applied to a standard stainless steel or corrugated substrate at a rate of 24 in./min. with a 41 h pound rubber covered roller according to the method. The sample was then peeled from the substrate at a 90° angle with a dwell time of sixty seconds or sixty minutes. The force required for removal was measured, averaged, and the mode of failure noted. Three replicates of each sample were tested. Table 1 displays results from tests carried out on stainless steel while Table 2 displays results from tests carried out on corrugated cardboard.

TABLE 1
90° Peel Adhesion to Stainless Steel

| | Coat | 60 Second Dwell | | | | 60 Minute Dwell | | | |
|---|---|---|---|---|---|---|---|---|---|
| Sample | Weight | Avg. (grams/ | | | | Avg. (grams/ | | | |
| I.D. | grams/m² | 25 mm²) | σ | n | MOF | 25 mm²) | σ | n | MOF |
| 1 | 12.5 | 158.4 | 26.3 | 3 | A | 286.5 | 38.2 | 3 | A |
| 2 | 20.0 | 118.0 | 6.7 | 3 | A | 386.4 | 12.1 | 3 | A |
| 3 | 13.5 | 137.8 | 12.2 | 3 | A | 223.1 | 30.4 | 3 | A |

Table 1: Results of 90° Peel Adhesion to Stainless Steel.
AVG.—the average value of the replicates
σ—standard deviation
n—number of replicates
MOF—mode of failure
Numbers 1 to 9 = %, as A8T2 is an 80% clean peel with 20% transfer of the adhesive to the substrate.
A—adhesive failure - the adhesive was removed from the substrate cleanly.
T—adhesive transfer - the adhesive transferred from the face stock to the substrate. Usually attributed to poor anchorage.
Numbers 1 to 3—1 = slight 2 = moderate 3 = severe
L—legging - the condition of a soft adhesive when strings or legs are formed when it is pulled.

TABLE 2
90° Peel Adhesion to Corrugated

| | Coat | 60 Second Dwell | | | | 60 Minute Dwell | | | |
|---|---|---|---|---|---|---|---|---|---|
| Sample | Weight | Avg. (grams/ | | | | Avg. (grams/ | | | |
| I.D. | grams/m² | 25 mm²) | σ | n | MOF | 25 mm²) | σ | n | MOF |
| 1 | 12.5 | 474.7 | 69.7 | 3 | A | 643.3 | 11.4 | 3 | SD |
| 2 | 20.0 | 524.9 | 24.9 | 3 | A1SD7FT5 | 520.6 | 78.2 | 3 | A4SD6 |
| 3 | 13.5 | 428.1 | 15.5 | 3 | A | 610.7 | 28.6 | 3 | SD9FT1 |

Table 2: Results of 90° Peel Adhesion to Corrugated.
AVG.—the average value of the replicates
σ—standard deviation
n—number of replicates
MOF—mode of failure
Numbers 1 to 9 = %, as A2 SD8 is a 20% clean peel with 80% substrate delamination.
A—adhesive failure - the adhesive was removed from the substrate cleanly.
FD—face delamination - the face stock delaminated or separated during testing. The adhesive bond strength exceeded the internal strength of the face material.
SD—substrate delamination - the substrate delaminated or tore during testing. The adhesive bond strength exceeded the internal strength of the substrate.
Numbers 1 to 3—1 = slight 2 = moderate 3 = severe
L—legging - the condition of a soft adhesive when strings or legs are formed when it is pulled.

In addition to peel adhesion tests, dynamic shear tests were conducted. Dynamic shear was measured by a modified ASTM D 1002 method on a ChemInstruments DS-1000 Dynamic Shear Tester (Mentor, Ohio). The modification of the method related directly to activating the adhesive agent layer prior to the application of the liner-free solvent sensitive adhesive label to the substrate. The liner-free solvent sensitive adhesive labels were prepared in a manner so that a 1 inch by 1 inch surface of the label made contact with the substrate. These samples were prepared as required by ASTM D3654 to perform a static shear test.

A 1 inch by 1 inch surface contact area of the adhesive sample was applied to the stainless steel substrate and allowed to dwell for 5 minutes. The test sample was then pulled apart in the plane of the substrate at a rate of about 0.05 inch per minute. The peak force required to separate or break the sample was recorded and the mode of failure noted. Three replicates of each sample were tested. Table 3 summarizes the results of the dynamic shear tests.

TABLE 3
Dynamic Shear

| | |
|---|---|
| Coat | 5 Minute Dwell |

| Sample | Weight | Max (grams/ | | | |
|---|---|---|---|---|---|
| I.D. | grams/m² | 25 mm²) | σ | n | MOF |
| 1 | 12.5 | 13427.1 | 901.7 | 3 | FT |
| 2 | 20.0 | 13083.9 | 51.5 | 3 | FT |
| 3 | 13.5 | 14142.8 | 489.3 | 3 | FT |

Table 3: Summary of results of dynamic shear of various samples.
MAX.—the maximum value of each replicate test
σ—standard deviation
MOF—mode of failure
Numbers 1 to 9 = %, as A9T1 is a 90% clean peel with 10% transfer of the adhesive to the substrate.
C—cohesive failure - the adhesive split, leaving residue on both the face stock and substrate.
FT—face tear - the face stock broke or tore during testing. The adhesive bond strength exceeded the internal strength of the face material.

In addition to the peel adhesion and dynamic shear tests performed on samples of solvent-sensitive adhesive liner-free labels 490 prepared in accordance to the teachings and methods described above, the same peel adhesion and dynamic shear tests performed on the solvent-sensitive adhesive liner-free label samples were performed using samples of pressure-sensitive adhesive label samples, such as the Z-Perform 2000D Thermal Shipping Label from Zebra Technologies (Lincolnshire, Ill.). The pressure-sensitive adhesive label sample contained a face stock, a pressure-sensitive adhesive layer, and a release liner. The release liner was manually removed from the pressure-sensitive adhesive layer immediately prior to application to the test substrates. The samples were applied and removed from the test substrates in the same manner as described above for the solvent-sensitive adhesive liner-free label samples, and in accordance with the test protocols. The pressure sensitive-adhesive label samples were tested as a means of comparison between the solvent-sensitive adhesive liner-free labels described here and existing of pressure-sensitive adhesive labels.

Table 4 summarizes the results of the 90° Peel Adhesion to Stainless Steel Test for the pressure-sensitive adhesive label sample (sample I.D. “Control”).

TABLE 4
90° Peel Adhesion to Stainless Steel

| | 60 Second Dwell | | | | 60 Minute Dwell | | | |
|---|---|---|---|---|---|---|---|---|
| | Avg. | | | | Avg. | | | |
| Sample | (grams/ | | | | (grams/ | | | |
| I.D. | 25 mm²₎ | σ | n | MOF | 25 mm²₎ | σ | n | MOF |
| Control | 986.1 | 118 | 3 | A, L2 | 1143.5 | 20.4 | 3 | A |

Table 4: Results of 90° Peel Adhesion to Stainless Steel.
AVG.—the average value of the replicates
σ—standard deviation
n—number of replicates
MOF—mode of failure
Numbers 1 to 9 = %, as A8T2 is a 80% clean peel with 20% transfer of the adhesive to the substrate.
A—adhesive failure - the adhesive was removed from the substrate cleanly.
T—adhesive transfer - the adhesive transferred from the face stock to the substrate. Usually attributed to poor anchorage.
Numbers 1 to 3—1 = slight 2 = moderate 3 = severe
L—legging - the condition of a soft adhesive when strings or legs are formed when it is pulled.

Table 5 summarizes the results of the 90° Peel Adhesion to Corrugated Test for the pressure-sensitive adhesive label sample (sample I.D. “Control”).

TABLE 5
90° Peel Adhesion to Corrugated

| | 60 Second Dwell | | | | 60 Minute Dwell | | | |
|---|---|---|---|---|---|---|---|---|
| | Avg. | | | | Avg. | | | |
| Sample | (grams/ | | | | (grams/ | | | |
| I.D. | 25 mm²₎ | σ | n | MOF | 25 mm²₎ | σ | n | MOF |
| Control | 205.2 | 69.7 | 3 | A | 212.6 | 11.4 | 3 | SD |

Table 5: Results of 90° Peel Adhesion to Corrugated.
AVG.—the average value of the replicates
σ—standard deviation
n—number of replicates
MOF—mode of failure
Numbers 1 to 9 = %, as A2 SD8 is a 20% clean peel with 80% substrate delamination.
A—adhesive failure - the adhesive was removed from the substrate cleanly.
FD—face delamination - the face stock delaminated or separated during testing. The adhesive bond strength exceeded the internal strength of the face material.
SD—substrate delamination - the substrate delaminated or tore during testing. The adhesive bond strength exceeded the internal strength of the substrate.
Numbers 1 to 3—1 = slight 2 = moderate 3 = severe
L—legging - the condition of a soft adhesive when strings or legs are formed when it is pulled.

Table 6 summarizes the results of the dynamic shear tests for the pressure-sensitive adhesive label sample (sample I.D. “Control”).

TABLE 6
Dynamic Shear

5 Minute Dwell

| Sample | Max (grams/ | | | |
|---|---|---|---|---|
| I.D. | 25 mm²) | cr | n | MOF |
| Control | 9074.0 | 245.2 | 3 | C |

Table 6: Summary of results of dynamic shear of various samples. MAX.—the maximum value of each replicate test
σ—standard deviation
MOF—mode of failure
Numbers 1 to 9 = %, as A9T1 is a 90% clean peel with 10% transfer of the adhesive to the substrate.
C—cohesive failure - the adhesive split, leaving residue on both the face stock and substrate.

The peel adhesion to corrugated substrate results showed that the solvent-sensitive adhesive liner-free labels 490 (Sample 1, Sample 2, Sample 3) have peel adhesion strength to corrugated of at least twice as great as the peel adhesion strength to corrugated of a commercially available pressure sensitive adhesive label (Control). The implications of these results are significant commercially, as different applications require different peel adhesion strengths. For example, a variable information or barcode label applied to a corrugated substrate—as found in such commercial applications as the parcel industry and logistics and distribution operations of wholesalers, retailers, manufacturers, and the like—may require high peel adhesion strength, to guarantee the label adhesion to the substrate throughout the shipping process. In other commercial applications, for example price marking labels used by retailers and wholesalers, a price marking label may be desired to possess low peel adhesion strength, so that the label may be removed and replaced relatively easily.

Further testing was focused on reducing the time taken for the solvent-sensitive adhesive agent layer 496 to form a bond with a substrate. Additional formulations of the solvent-sensitive adhesive agent layer 496 were tested using a modified peel adhesion test according to a modified ASTM D 3330 method F. The modifications included testing at a variable dwell time. Sequential tests starting at a 60 second dwell time were performed, with each subsequent test being performed at a shorter dwell time. The test concluded when peeling no longer caused fiber tearing as the mode of failure. The purpose of this test was to gauge the minimum time needed to form a bond strong enough to cause fiber tear as the mode of failure. Another modification included testing on a corrugated cardboard substrate. All samples of the solvent-sensitive adhesive agent layer of the solvent-sensitive liner-free adhesive labels were activated by de-ionized water sprayed from a hand controlled spray nozzle just prior to application. Results are reported in Table 7 as average minimum time needed before fiber tear occurs as the mode of failure.

TABLE 7
Dwell time required to cause fiber tear as mode of failure for various adhesive
formulations. The same activation solvent (Solvent Formulation A) was used
for all tests. Note: w-v indicates a weight to volume percentage.

| | Adhesive Formulation | | | | | | |
|---|---|---|---|---|---|---|---|
| | A | B | C | D | E | F | G |
| | Percentage of Ingredient/Additive | | | | | | |
| Poly(vinyl alcohol) (PVOH) (25% w-v | 100.0% | 95.2% | 94.3% | 89.3% | 94.3% | 97.6% | 97.1% |
| in water) (Celvol ® 205) | | | | | | | |
| Ethylene vinyl acetate (EVA) (55% w- | — | 4.8% | — | — | — | — | — |
| v in water) (Vinnapas ® EP 400) | | | | | | | |
| Methyl Cellulose (100% w-v in water) | — | — | 1.9% | — | — | — | — |
| Water | — | — | 5.7% | 8.0% | — | — | — |
| 2-Pyrrolidinone, 1-ethenyl | — | — | — | 2.7% | — | — | — |
| homopolymer (100% w-v in water) | | | | | | | |
| (also called polyvinylpyrrolidone | | | | | | | |
| (PVP)) | | | | | | | |
| Poly(acrylic acid) (25% w-v in water) | — | — | — | — | 5.7% | — | — |
| (Carbosperse ™ K-702 Polyacrylate) | | | | | | | |
| Polyethylenglycol (PEG) (100% w-v in | — | — | — | — | — | 2.4% | — |
| water) | | | | | | | |
| Glycerin (100% w-v in water) | — | — | — | — | — | — | 3.0% |
| Dwell Time to Fiber Tear (seconds) | 21.0 | 17.3 | 90.0 | 35.5 | 18.5 | 25.8 | 34.0 |

Formulations B and E were further investigated and evaluated because they exhibited a lesser dwell time to fiber tear than the additive free Formulation A. Formulations A, B, and E were made and tested using a modified peel adhesion test according to a modified ASTM D 3330 method F. The modification included testing the peel strength after a 20 second dwell time, and also testing the peel strength after a 40 second dwell time. Results are reported as the average force required to peel the label from the cardboard substrate in Table 8.

TABLE 8
Peel strength tests with dwell times of 20 and 40 seconds.

| | 20 Second Dwell | | | 40 Second Dwell | | |
|---|---|---|---|---|---|---|
| | Ave. (grams/ | | | Ave. (grams/ | | |
| Formulation | 25 mm² | σ | n | 25 mm²) | σ | n |
| A | 9.55 | 4.94 | 2 | 10.19 | 2.65 | 6 |
| B | 9.99 | 2.68 | 6 | 14.52 | 3.62 | 6 |
| E | 12.74 | 2.18 | 5 | 13.92 | 4.51 | 6 |

The above tests evaluated a variety of possible adhesive formulations using eight different possible additives. Similar additives, ingredients, or excipients that may be used as replacements or in addition to those listed include, but are not limited to, remoistenable adhesives such as Craigbond 3425BT, 3425QT, and 3195W from Craig Adhesives and Coatings (Newark, N.J.), Reynco 123-75 from the Reynolds Company (Greenville, S.C.), Duracet RM (Franklin Adhesives and Polymers, Ohio), Royal Products BR-5177 and BR-4227 from Royal Adhesives and Sealants (South Bend, Ind.), BondPlus 347M from Industrial Adhesives (Chicago, Ill.), and other Cabrosperse K-700 series polymer systems from The Lubrizol Corporation (Wickliffe, Ohio). Also, other water soluble materials besides glycerin such as glycols, urea, citrates, sugars, sorbitol, polyethylene oxide, other grades of PEG and PVP, polyethyloxazoline, gelatin, polyacylamide copolymers, cellulose types such as CMC or EHEC, pectin, casein, polyacrylic acid as well as gums such as alginates, agar, arabic, carrageen, ghatti, guar, karaya, locust bean, tragacanth, and xanthenes may also be used or substituted in a similar manner.

As the test results indicate, the peel adhesion strength is easily manipulated for the solvent-sensitive adhesive agent layer 496 and as such, the solvent-sensitive adhesive liner-free label 490 and the solvent-sensitive adhesive agent layer 496 has applications in a variety of commercial fields including, without limitation: paper labels, thermally activated paper labels, labels used in the parcel industry, labels used in logistics and distribution operations of wholesalers, retailers, manufacturers, and the like; bar code labels; variable information labels; merchandise labels used in the operations of wholesalers and retailers; commercially printed product (or primary) labels; construction adhesives; and labels applied to plastic or glass substrates such as, without limitation, wine labels and beverage labels.

The dynamic shear results suggest the solvent-sensitive adhesive agent layer 496 of the solvent-sensitive adhesive liner-free label (Sample 1, Sample 2, Sample 3) has a shear value at least 4000 grams/25 mm² higher than that of a commercially available pressure-sensitive adhesive label (Control). A high shear strength, with a moderate peel adhesive strength, is a desirable quality for an adhesive label, as it allows misplaced labels to be deliberately removed by peeling the label from the substrate; however, the label will not slide or unintentionally fall off of the substrate.

This disclosure also relates to solvents used to activate an adhesive agent layer. One embodiment of a solvent used to activate the adhesive contains at least about 95% water by weight, with a remaining about 5% being composed of one or more biocides to prevent biological activity within the product. Biocides may include, but are not limited to, chlorine, 2-bromo-2-nitropropane-1,3-diol (bronopol), sodium o-phenylphenate, Diiodomethyl-p-tolylsulfone, and combinations thereof. In alternative embodiments, the solvent may include any mix of solvents that dissolve the corresponding adhesive composition including, but not limited to water, isopropyl alcohol, ethanol, and combinations thereof.

Some testing focused heavily on reducing the time taken for the adhesive to form a bond with the substrate. In order to accomplish this, a variety of non-toxic solvents were tested as the application solvent for the solvent sensitive adhesive liner-free label 490. The majority of these solutions primarily contained water with a dilute mix or blend of other solvent(s). A modified ASTM D 3330 method F test was conducted. The modification involves performing sequential testing, starting with a 60 second dwell time, and shortening the dwell time on each subsequent test. The test concluded when peeling no longer caused fiber tearing as the mode of failure. The purpose of this was to gauge the minimum time needed to form a bond strong enough to cause fiber tear as the mode of failure. One formulation of the solvent-sensitive adhesive agent layer 496 was used for all tests. The solvent blend was the variable being tested. All samples of the solvent-sensitive adhesive agent layer 496 of the solvent-sensitive liner-free adhesive labels 490 were activated by an equal volume of solvent sprayed from a hand controlled spray nozzle just prior to application. Results in Table 9 are an average minimum time before fiber tear occurs as the mode of failure.

TABLE 9
Dwell time required to cause fiber tear as mode of failure for various solvent formulations.
The same adhesive formulation (Adhesive Formulation A) was used for all tests.

| Activation | A | B | C | D | E | F | G | H | I |
|---|---|---|---|---|---|---|---|---|---|
| Solvent | Percent Content of Ingredient | | | | | | | | |
| DI Water | 100.0% | 93.0% | 93.0% | 93.0% | 93.0% | 97.0% | 98.5% | 95.0% | 97.5% |
| Methanol | — | 7.0% | — | — | — | — | — | — | — |
| Ethanol | — | — | 7.0% | — | — | — | — | — | — |
| Isopropanol | — | — | — | 7.0% | — | — | — | 2.0% | 1.0% |
| N-propanol | — | — | — | — | 7.0% | 3.0% | 1.5% | 3.0% | 1.5% |
| Dwell Time to | 28 | 38.3 | 35.7 | 31.7 | 25.7 | 22.7 | 24 | 27 | 22.7 |
| Fiber Tear | | | | | | | | | |
| (seconds) | | | | | | | | | |

Solvent Formulations F, G, and I were further investigated and evaluated as they had a lower required dwell time needed to accomplish fiber tear as the mode of failure as compared to the additive free Solvent Formulation A. In order to accomplish this, formulations A, F, G, and I were made and tested using a modified peel adhesion test according to a modified ASTM D 3330 method F. The modification included testing the peel strength after a 20 second dwell time and also testing the peel strength after a 40 second dwell time. Results are reported as the average force required to peel the label from the cardboard substrate in Table 10. All tests were performed using Adhesive Formulation A.

TABLE 10
Peel strength tests with dwell times of 20 and 40 seconds with
various solvent formulations.

| | 20 Second Dwell | | | 40 Second Dwell | | |
|---|---|---|---|---|---|---|
| Solvent | Ave. (grams/ | | | Ave. (grams/ | | |
| Formulation | 25 mm²) | σ | n | 25 mm²) | σ | n |
| A | 8.35 | 3.01 | 4 | 9.72 | 4.33 | 6 |
| F | 9.89 | 1.48 | 6 | 13.62 | 5.69 | 3 |
| G | 14.24 | 0.71 | 3 | 10.90 | 5.28 | 6 |
| I | 9.23 | 3.24 | 4 | 11.70 | 3.67 | 6 |

Additional experiments were conducted, using a similar method as above, to better understand the impact of different activation solvent formulations (Solvent Formulations A, F, G, and I) on different adhesive agent layer 496 formulations (Adhesive Formulations A, A1, A2, B1, B2, B3, B4, and B5 from Table 11). To accomplish this, the same modified peel adhesion test according to ASTM D 3330 method F as described above was employed. Results are reported as the average force required to peel the label from a cardboard substrate taken as the average over five tests. Solvent Formulations A, F, G, and I were each used to activate the solvent sensitive adhesive agent layer 496 of the solvent sensitive label 490 made with Adhesive Formulations A, A1, A2, B1, B2, B3, B4, or B5. Results at the 20-second dwell time (Q) and the 40-second dwell time (L) are given in U.S. Pat. No. 9,085,384, the contents of which are incorporated herein by reference in their entirety.

TABLE 11

| | Adhesive Formulation | | | | | | | |
|---|---|---|---|---|---|---|---|---|
| | A | A1 | A2 | B1 | B2 | B3 | B4 | BS |
| | Percent Composition | | | | | | | |
| Poly(vinyl alcohol) (PVOH) (25% w-v in | 100% | 95.2% | 94.3% | 94.8% | 85.8% | 97.1% | 90.9% | 92.2% |
| water) (Celvol ® 205) | | | | | | | | |
| Ethylene vinyl acetate (EVA) (55% w-v in | — | 4.8% | — | 2.4% | 6.4% | — | — | 2.3% |
| water) (Vinnapas ® EP 400) | | | | | | | | |
| Water | — | — | — | 2.8% | 7.7% | — | — | 2.8% |
| Poly(acrylic acid) (25% w-v in water) | — | — | 5.7% | — | — | 2.9% | 9.1% | 2.8% |
| (Carbosperse ™ K-702 Polyacrylate) | | | | | | | | |

The results summarized in Tables 9, 10, and 12 indicate that altering the activation solvent affects the adhesive behavior of the solvent-sensitive adhesive label 490. The results also suggest that the adhesive profile of the label 490 may be adjusted based on a selection of solvent and co-solvent blends. This is of significance commercially, as different applications require different adhesive profiles. For example, in certain applications, a weak initial peel strength followed by a curing period where the peel strength increases greatly may be preferred, such as that provided by a combination of Adhesive Formulation A2 and Solvent Formulation G. This would allow for misplaced labels to be corrected before a permanent adhesive bond is formed. Other applications, such as high throughput labeling applications where it is critical to apply labels to substrates that are quickly moving on an automated assembly, packaging, and/or sorting line, would benefit from a higher initial peel strength value such as that provided by Adhesive Formulation B4 and Solvent Formulation G.

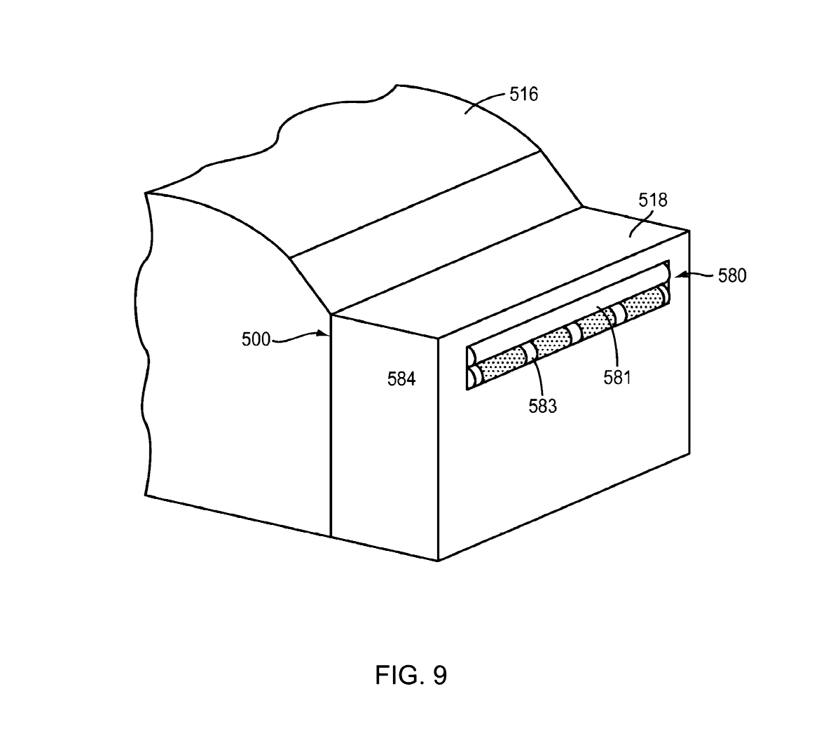

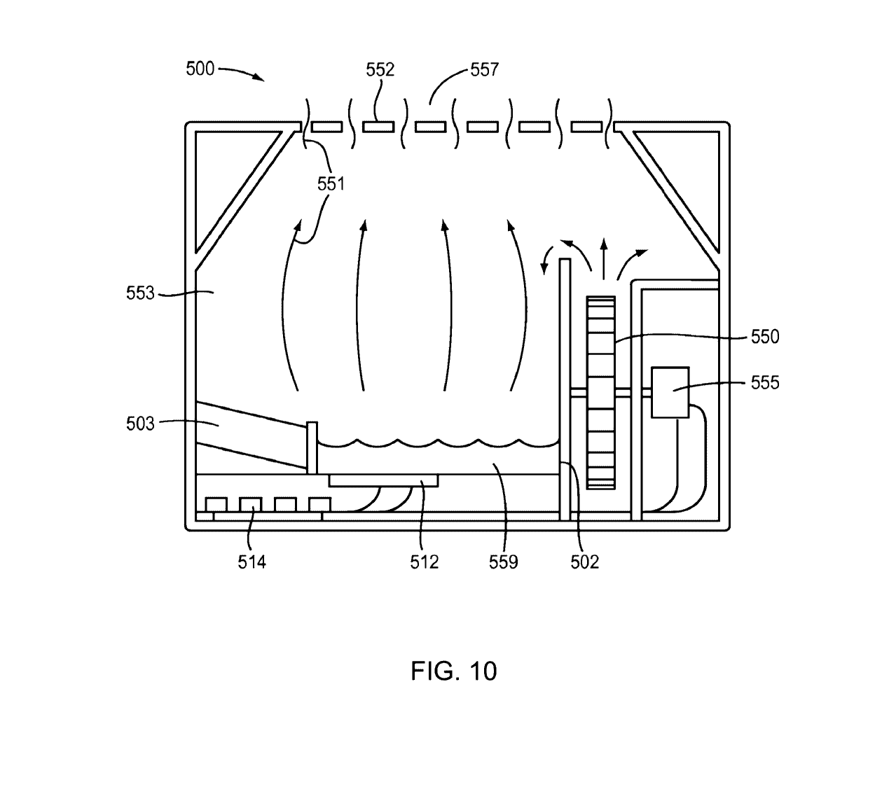

FIG. 9 depicts another embodiment of an activator assembly 500. The activator assembly 500 is attached to an end of a label printer 516 and is aligned such that a label exiting the label printer 516 will enter the activator assembly 500. The activator assembly 500, as depicted in FIGS. 9 and 10, includes a housing 518, a label moving or support mechanism 580, a solvent containing device 503, a solvent reservoir 502, an activating element 512, a fan assembly 550, distribution doors 552, and a control system/circuit board 514.

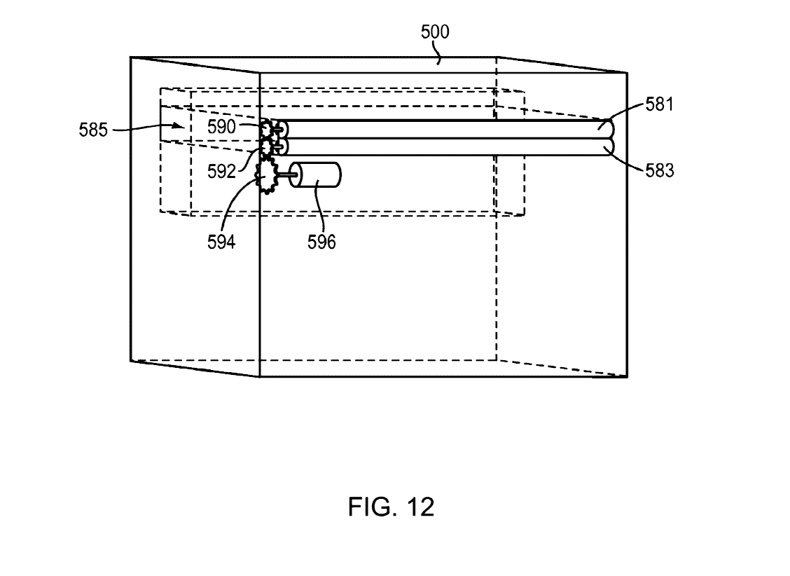

The housing 518 is of a suitable size to contain all of the components of the activator assembly 500. The housing 518 is sufficiently wide for a solvent-sensitive adhesive sheet to pass through, such as about four to six inches in width. On one surface, the housing 518 forms an opening to house the moving mechanism 580. The moving mechanism 580 includes an upper roller 581 and a lower roller 583, thereby defining an exit slot 584 between them. The upper roller 581 and the lower roller 583 are sufficiently spaced apart to guide a solvent-sensitive adhesive sheet between them, such as about zero millimeters to one-tenth of one millimeter, through which a solvent-sensitive adhesive sheet may travel. The upper roller 581 and the lower roller 583 can be linked together by a gear assembly 585 (depicted in FIG. 12) to help ensure they turn at the same rate to guide a solvent-sensitive adhesive sheet through the activator assembly 500 and the exit slot 584. The exit slot 584 may be aligned with a slot on the label printer 516 or other equipment where a solvent-sensitive adhesive sheet may exit. Alternatively, this activator assembly 500 may be used in a standalone configuration. The activator assembly 500, the exit slot 584, the upper roller 581, and the lower roller 583 may be made of any sufficiently rigid and strong material such as high-strength plastic, metal, and the like.

FIG. 10 depicts the internal components and configurations of the activator assembly 500 adapted to generate a solvent vapor/gas 551 for application to the adhesive layer of a label. The activating element 512 is located beneath the solvent reservoir 502. The activator assembly 500 also includes a vapor/gas reservoir 553 and a fan motor 555 connected to the fan 550. The pair of distribution doors 562 are located between the vapor/gas reservoir 553 and an activation site 557.

A solvent 559 is excited to the state of the vapor/gas 551 by the activating element 512, at which point the solvent 559 is suspended as the vapor/gas 551 in the vapor/gas reservoir 553. In various embodiments, the activating element 512 may be a heater element, a piezoelectric element, or other suitable device. The fan motor 555 drives the fan 550 to create an air current in the vapor/gas reservoir 553. The air current moves the vapor/gas 551 from the vapor/gas reservoir 553 through the pair of distribution doors 552 to the activation site 557. The circuit board 514 controls the activating element 512 and the fan motor 555. The circuit board 514 is connected to central electronics in the label printer 516, such that internal components of the label printer 516 can interact with the circuit board 514 and internal components of the activator assembly 500.

In further detail, still referring to FIG. 10, the solvent containing device 503 may supply ample volume of the solvent 559 to fill the solvent reservoir 502. The solvent reservoir 502 contains ample volume of the solvent 559 to render tacky a reasonably large area of adhesive on solvent-sensitive adhesive sheet. The activating element 512 operates at an intensity to excite the solvent 559 from a liquid state into the vapor/gas 551. The vapor/gas reservoir 553 should be of ample volume to contain a sufficient amount of the solvent 559 in the state of the vapor/gas 551 to render tacky a reasonably large area of adhesive on solvent-sensitive adhesive sheet. The fan motor 555 and the fan 550 move an ample volume of the vapor/gas 551 to the activation site 557. The pair of distribution doors 562 contain the vapor/gas 551 to the vapor/gas reservoir 553 when closed and allow an ample amount of the vapor/gas 551 to pass through to the activation site 557 when open. The circuit board 514 is sized to fit within the boundaries of the activator assembly 500, underneath the solvent reservoir 502, and underneath the activating element 512.

The solvent reservoir 502, the activating element 512, the vapor/gas reservoir 553, the fan motor 555, the fan 550, the distribution doors 552, the circuit board 514, and the solvent containing device 503 may be made of any sufficiently rigid and strong material such as high-strength plastic, metal, and the like. The solvent 559 consists of a material that, when in the state of the vapor/gas 551, is capable of rendering tacky the adhesive agent layer of the adhesive sheet. Further, the various components of the activator assembly 500 can be made of materials that do not degrade over time with exposure to the solvent 559 and the vapor/gas 553.

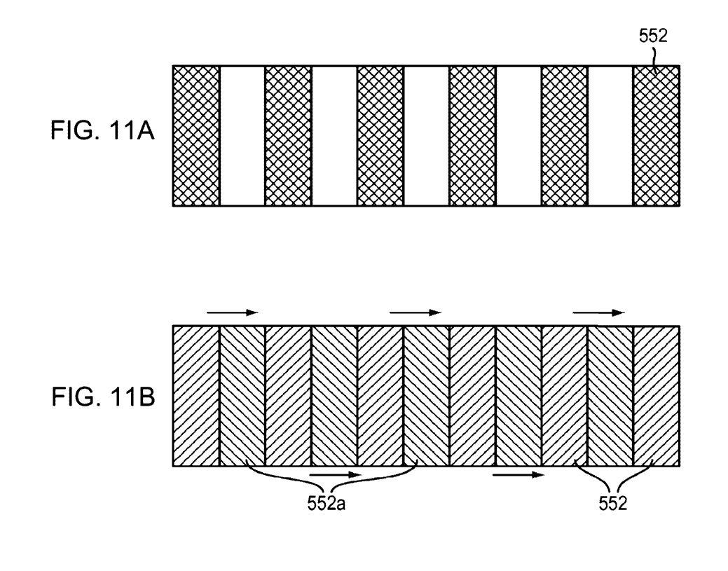

FIGS. 11A and 11B depict the pair of distribution doors 552 at the approximate time an adhesive sheet is fed thereby (FIG. 11A) and thereafter (FIG. 11B). The distribution doors 552 open and close. When the pair of distribution doors 552 are open, respective openings in the pair of distribution doors 552 align with each other to allow multiple channels for the vapor/gas 551 to pass through the distribution doors 552 from the vapor/gas reservoir 553 to the activation site 557. Once the sheet passes by, the pair of distribution doors 552 are closed by one door 552a sliding laterally so as to close all channels between the vapor/gas reservoir 553 and the activation site 557.

In further detail, still referring to FIGS. 11A and 11B, the pair of distribution doors 552 have identical slats of width of about 0.125 inches to 0.5 inches. Both doors 552 are of sufficient width to allow enough of the vapor/gas 551 to pass through to render tacky the entire width of the adhesive agent layer of the adhesive sheet. The overall width of the pair of distribution doors 552 may be about two to five inches and about 0.25 inches to 2.0 inches in length. The pair of distribution doors 552 may be made of any sufficiently rigid and strong material such as high-strength plastic, metal, or the like.

FIG. 12 depicts the activator assembly 500 containing an upper gear 590, a lower gear 592, and a driving gear 594. The upper gear 590 is attached to the upper roller 581, and the lower gear 592 is attached to the lower roller 583. The driving gear 594 is attached to a driving motor 596. Finally, the driving motor 596 is connected to a secondary circuit board in the activator assembly 500.

In more detail, still referring to FIG. 12, the driving motor 596 is connected to the driving gear 594 within the activator assembly 500. The driving gear 594 meshes with the lower gear 592, which meshes with the upper gear 590. The lower gear 592 is connected on its axis to the lower roller 583. The upper gear 590 is connected on its axis to the upper roller 581. While the driving motor 596 is turning, the upper roller 581 and the lower roller 583 turn in opposite directions in such a way that a solvent-sensitive adhesive sheet will be guided through a slot of the activator assembly 500.

In further detail, still referring to FIG. 12, the upper roller 581 may be of a diameter of about 0.125 inches to 0.5 inches. The lower roller 583 may be similarly dimensioned. The upper gear 590 may be of a similar or equivalent diameter to that of the upper roller 581, and the lower gear 592 may be of a similar or equivalent diameter to that of the lower roller 583. The driving gear 594 may have a diameter of about 0.25 inches to 1.0 inch. The driving motor 596 should be of sufficient size to produce enough torque to guide the adhesive sheet through the activator assembly 500.

The activator assembly 500, the upper gear 590, the lower gear 592, the driving gear 594, the upper roller 581, the lower roller 583, and the driving motor 596 may be made of any sufficiently rigid and strong material such as high-strength plastic, metal, and the like. Further, the various components of the activator assembly can be made of different materials and may include rubber or silicone coatings.

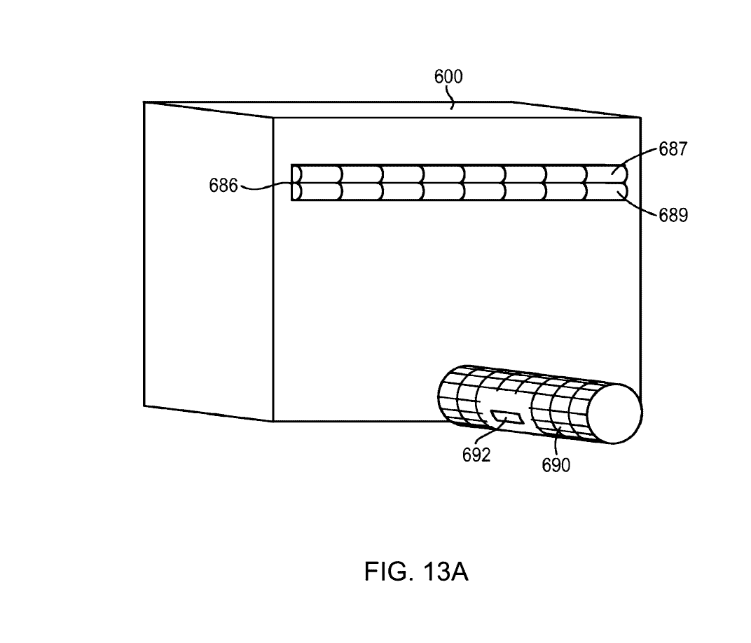

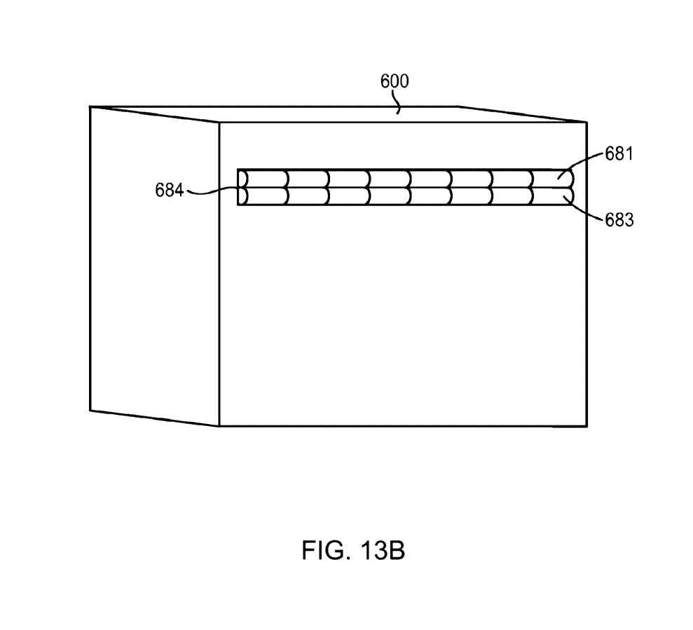

FIGS. 13A and 13B depict another embodiment of an activator assembly 600. The activator assembly 600 includes an entrance slot 686 that contains an entrance upper roller 687 and an entrance lower roller 689 driven by an entrance gear assembly (not shown). The activator assembly 600 also optionally includes an exit slot 684 that contains an exit upper roller 681, an exit lower roller 683, and an exit gear assembly (not shown). A handle 690 is attached to the activator assembly 600.

In more detail, still referring to FIGS. 13A and 13B, the adhesive sheet enters the activator assembly 600 via the entrance slot 684 and is guided by the entrance upper roller 687 and the entrance lower roller 689, which are linked by the entrance gear assembly, through the activator assembly 600 to the exit rollers 681, 683, and exit slot 684. The handle 690 enables the activator assembly 600 to be easily transported. A switch 692 located on the handle 690 communicates with a circuit board of the activator assembly 600. The switch 692 may be used to control the fan motor and the activating element within the activator assembly 600. The activator assembly 600 should remain generally horizontal during operation.

In further detail, still referring to FIGS. 13A and 13B, the activator assembly 600 is sufficiently wide for the solvent-sensitive adhesive sheet to pass therethrough, such as about four to six inches in width. The entrance rollers 687, 689 are sufficiently spaced apart for guiding the solvent-sensitive adhesive sheet between them, such as about zero millimeters to 0.1 mm. The entrance upper roller 687 may have a diameter of about 0.125 inches to 0.5 inches and the entrance lower roller 689 may have a similar diameter. Within the entrance gear assembly, an entrance upper gear may be of a similar or equivalent diameter of the entrance upper roller 687. Also, the entrance lower gear may be of a similar or equivalent diameter of the entrance lower roller 689. Within the activator assembly 600, the entrance upper roller 687 and the entrance lower roller 689 are linked together by the entrance gear assembly and rotate at a similar or equivalent rate to guide the solvent-sensitive adhesive sheet from the entrance slot 686 through the activator assembly 600.

The optional exit upper roller 681 and the optional exit lower roller 683 are sufficiently spaced apart for guiding the adhesive sheet between them, such as about zero millimeters to 0.1 mm. Within the activator assembly 600, the exit upper roller 681 and the exit lower roller 683 are linked together by an exit gear assembly and turn at a similar rate to guide the adhesive sheet out the exit slot 684. Within the exit gear assembly, an exit upper gear may be of a similar or equivalent diameter to that of the exit upper roller 681. Also, within the exit gear assembly, an exit lower gear may be of a similar or equivalent diameter to that of the exit lower roller 683. A driving gear may have a diameter of about 0.25 inches to 1.0 inch and may mesh with the entrance gear assembly and the exit gear assembly. A driving motor drives the driving gear. The driving motor is of sufficient size to produce enough torque to guide the adhesive sheet through the activator assembly 600. The handle 690 should be of a sufficient length and diameter so as to provide a means of supporting the weight and balance of the activator assembly 600, such as about three to seven inches in length and about 0.125 inches to 2.0 inches in diameter.

The activator assembly 600, the entrance slot 686, the entrance upper roller 687, the entrance lower roller 689, the entrance gear assembly, the exit slot 684, the exit upper roller 681, the exit lower roller 683, the exit gear assembly, the handle 690, and the switch 692 may be made of any sufficiently rigid and strong material such as high-strength plastic, metal, and the like. Further, the various components of the activator assembly 600 can be made of different materials.

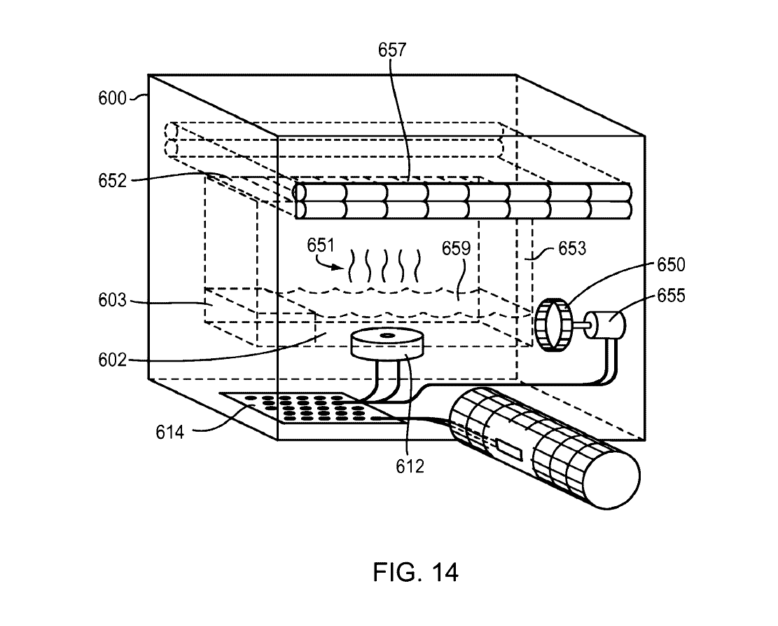

FIG. 14 depicts the internal configuration of components of the activator assembly 600 that contains a vapor/gas 651. The activator assembly 600 contains a solvent reservoir 602 configured for containing a solvent 659. An activating element 612 is located beneath the solvent reservoir 602. The activator assembly 600 further contains a vapor/gas reservoir 653 and a fan motor 655 connected to a fan 650. Between the vapor/gas reservoir 653 and an activation site 657 is a pair of distribution doors 652. The activator assembly 600 contains a control system/circuit board 614 and a solvent containing device 603.

In more detail, still referring to FIG. 14, the solvent 659 is placed in the solvent reservoir 602 contained within the activator assembly 600 such as, by way of, without limitation, the solvent containing device 603. The solvent containing device 603 is inserted into the activator assembly 600 to introduce the solvent 659 to the solvent reservoir 602. The solvent 659 is excited to the state of the vapor/gas 651 by the activating element 612, at which point the solvent 659 is suspended in the state of the vapor/gas 651 in the vapor/gas reservoir 653. The fan motor 655 drives the fan 650 to create an air current in the vapor/gas reservoir 653. The air current moves the vapor/gas 651 from the vapor/gas reservoir 653 through the pair of distribution doors 652 to the activation site 657. The circuit board 614 controls the activating element 612 and the fan motor 655. The circuit board 614 is disposed in the activator assembly 600 and is connected to central electronics in a label printer, such that, the fan motor 655, the activating element 612, and the pair of distribution doors 652 can be controlled effectively by the circuit board 614.

In further detail, still referring to FIG. 14, the solvent containing device 603 should supply ample volume of the solvent 659 to fill the solvent reservoir 602 and to render tacky a reasonably large area of adhesive on a solvent-sensitive adhesive sheet. The activating element 612 operates at an intensity to excite the solvent 659 from a liquid state into the vapor/gas 651. The vapor/gas reservoir 653 should be of sufficient volume to contain a reasonable amount of the solvent 659 in the state of the vapor/gas 651 to render tacky a reasonably large area of adhesive on the solvent-sensitive adhesive sheet. The fan motor 655 and the fan 650 move an ample volume of the vapor/gas 651 to the activation site 657. The pair of distribution doors 652 contain the vapor/gas 651 in a vapor/gas reservoir 653 when closed and allow an ample amount of the vapor/gas 651 to pass through to the activation site 657 when open. The circuit board 614 is sized to fit within the boundaries of the activator assembly 600, underneath the solvent reservoir 602, and underneath the activating element 612.

The activator assembly 600, the solvent reservoir 602, the activating element 612, the vapor/gas reservoir 653, the fan motor 655, the fan 650, the pair of distribution doors 652, the circuit board 614, and the solvent containing device 603 may be made of any sufficiently rigid and strong material such as high-strength plastic, metal, and the like. The solvent 659 consists of a material that, as a vapor/gas 651, is capable of rendering tacky the adhesive agent layer of the adhesive sheet. Further, the various components of the activator assembly 600 can be made of different materials that are resistant over time to exposure to the solvent 659 and the vapor/gas 651.

In operation, the adhesive sheet is guided to the activation site 657 in the activator assembly 600 for solvent activation. At the activation site 657, the adhesive agent layer is rendered tacky by exposure to the solvent vapor/gas 651 from the vapor/gas reservoir 653, through the pair of distribution doors 652. The activated solvent-sensitive adhesive sheet is then guided through an exit slot of the activator assembly 600.

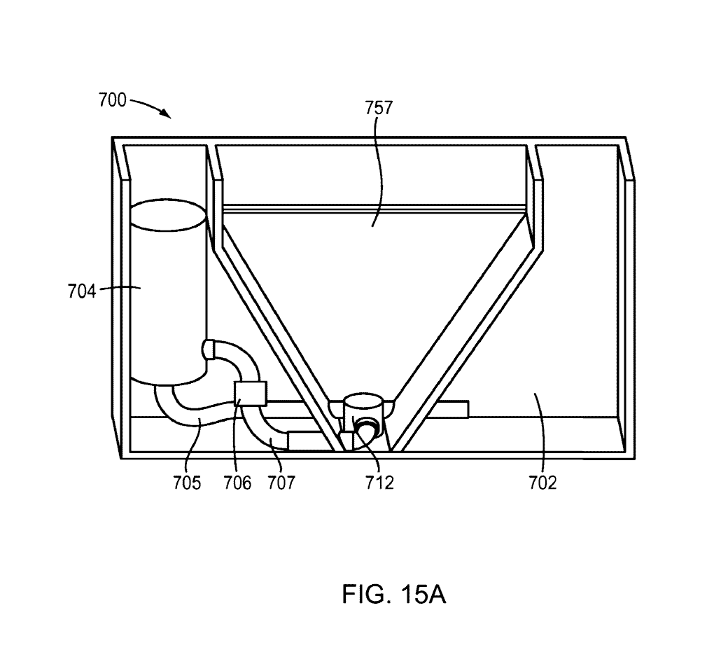

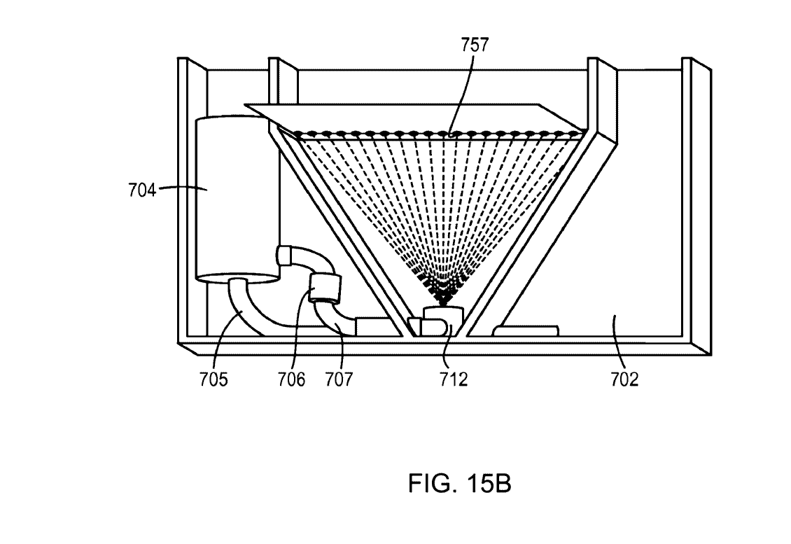

FIGS. 15A and 15B depict another embodiment of an activator assembly 700. The activator assembly 700 includes a solvent reservoir 702, a pump 704, a feeding tube 705, a check valve 706, a pressure tube 707, a nozzle 712, and an activation site 757.

The solvent reservoir 702 holds a liquid solvent (such as any of those previously discussed). The reservoir 702 may be substantially liquid-tight, and have a capacity equal to or more than the amount of liquid solvent required to activate one roll of liquid solvent-sensitive adhesive liner-free label. In one embodiment, the reservoir 702 is integrally formed within a housing of the activator assembly 700, though a separate permanently mounted container or replaceable reservoir cartridge could be used.

The pump 704 pressurizes solvent drawn from the reservoir 702. In one embodiment, the pump 704 may be of the type used for pressurizing windshield washer fluid in a vehicle. The pump 704 may be connected to and packaged with a single DC motor as an integral assembly. One embodiment utilizes a direct current motor that operates with a potential difference of around 6 to 30 volts DC. The embodiment depicted in FIGS. 15A and 15B has a DC motor included in a same housing as the pump 704. Some alternative embodiments include a single DC motor that drives a separate pump or multiple separate pumps that is/are connected by either a mechanical or magnetic interface or other suitable arrangement. Another embodiment includes several pumps and has several motors to drive each pump individually.

Various embodiments of the activator assembly 700 include one or several self-priming or non-self-priming centrifugal pumps. Another embodiment includes one or several flexible impeller pumps. Yet another embodiment includes one or several positive displacement pumps. The reservoir 702 is selected/designed to have a sufficient capacity, so that one full reservoir or cartridge of liquid solvent will activate at least one roll of labels.

The feeding tube 703 draws fluid from the solvent reservoir 702 to an inlet of the pump 704. In one embodiment a rubber/plastic tube having a nominal inner diameter of about 0.25 inches may be used, such as air line tubing intended for use in fish tank filtration systems. Once pressurized by the pump 704, high pressure fluid solvent passes through the check valve 706.

The check valve 706 prevents a flow of liquid solvent in the system from travelling in a reverse direction. In some scenarios with differing solvent fluid (e.g., water) levels and pressures, the check valve 706 only allows liquid to flow in the intended direction. One embodiment uses a check valve 706 typically used in an air line of a fish tank filtration system.

The pressure tube 707 transports high pressure liquid solvent from the check valve 706 to the spray nozzle(s) 712. The pressure tube 707 may be similar to the feeding tube 705 in material and configuration.

The nozzle 712 dispenses high-pressure liquid solvent as a mist or as a vapor. One embodiment uses a single nozzle, similar to the type used in a manual trigger-spray bottle, to produce a generally conical spray pattern. Other embodiments use a precision nozzle that sprays in a flat fan pattern. Still other embodiments include multiple nozzles 712 that receive pressurized liquid from either one or multiple pumps 704.

The activation site 757, though not a physical component, is important to the functionality and reliable operation of the activator assembly 700 based on its size and orientation. The activation site 757 is the physical location where liquid solvent (e.g., in mist or vapor form) comes into contact with the dormant polymer adhesive layer on a back of a liquid solvent-sensitive adhesive liner-free label. The activation site 757 is located a sufficient distance away from the nozzle 712, allowing the solvent mist or vapor fan or other spray pattern to disperse to activate an entire width of the dormant polymer adhesive layer on the back of the liquid solvent-sensitive adhesive liner-free label.

In one embodiment, the activator assembly 700 is designed to work autonomously, as a retrofit to current label printers. In one embodiment, the only control input required to turn the apparatus on and off is the supply of DC current to the motor(s). When current is supplied, the pump(s) 704 pressurize(s) the activator assembly 700 and a liquid solvent is ejected from the nozzle(s) 712 and delivered to the activation site 757. In one embodiment, an electrical current signal to the motor is governed by a printed circuit board that interfaces with a control output available on an attached printer of the type to control accessories, such as automatic cutters, rewinders, etc. The pump(s) 704 is turned on as a label is printed and passes over the activation site 757. The pump 704 is turned off after the label passes through the activation site 757 and activation is complete. Power to run the motor and the pump 704, as well as the control, can be integral with the activator assembly 700 (e.g., a battery or plug and transformer to accept line voltage) or can be provided by an attached printer with a suitable electrical cable.

The activator assembly 700 is adapted to integrate with label printers, and adds an additional set of actions that occurs at the end of the printing process. The activator assembly 700 is intended to be retrofit to the label dispensing end of any printer, though it may also be attached to alternative devices, such as a label applicator. The process in the activator assembly 700 can follow after (in order) the imaging process and the automatic label cutting process.

In operation, the activator assembly 700 adds additional steps to the printing process. Processes that would normally occur in a label printer without an activation apparatus are initial steps 1-3 and 7-8 inclusive, and processes that are performed as a result of the inclusion of the attached activator assembly 700 to the printer include steps 4-6 and 9 (including sub-steps).

First, a printer is sent a command, and outline, for a printed label from a computer. Second, the printer begins to print a label, the printhead creating an image on the top of the label and the platen driving the label forward and out of the printer. Third, the lead edge of the printed label passes through a cutter.

Fourth, a lead edge of the printed label enters the activator assembly 700. Fifth, as the lead edge enters the activation apparatus, the following activation process is initiated: the printer or other control system sends an electronic signal to a printed circuit board of the activator assembly 700 to begin the activation process; the printed circuit board of the activator assembly 700 begins to supply electricity to the pump 704; when supplied with electricity, the pump 704 turns on and begins to pressurize solvent; as the system becomes pressurized, solvent is forced from the nozzle 712; while solvent within the activator assembly 700 is being ejected, the pump 704 continuously draws new solvent to be pressurized from the solvent reservoir 702; as solvent is forced from the nozzle 712, its spray pattern is dictated by a shape and size of the aperture of the nozzle 712 (the nozzle 712 is selected to distribute solvent in a mist/vapor form to the entire activation site 757, which may be the width of a variable label and the bounds of which the distribution of a solvent spray in a mist/vapor form should not exceed); a spray area governed by the nozzle 712 creates the activation site 757 (a controlled, closed system within the activator assembly 700) where the label can be activated and rendered ready for use. Sixth, as the activator assembly 700 has been turned on, the printed label becomes activated as it is driven through the activation site 757 by the printer. The combination of drive speed, system pressure, and nozzle shape are optimized, such that a uniform supply of solvent is delivered across a suitable area of the label in an appropriate volume to effectively activate the label's adhesive.

Seventh, as the label printing process is finishing, a trailing edge of the printed label passes through the cutter, at which time the label is cut and separated from a label stock roll. Eighth, after the label is cut from the label stock roll, the operator, label transfer device or other arrangement can remove the label from the printer. Ninth, as the label is removed, the trailing edge passes through the activator assembly 700 and activation fluid is applied to the trailing portion of the label. Once the trailing edge has left the activator assembly 700, the activation process is complete. The printed circuit board ceases to supply electricity to the pump 704, the activator assembly 700 ceases to have pressure, and solvent ceases to be forced from the nozzle 712. The activator assembly 700 is turned off.

Additional details about liner-free labels and systems can be found in U.S. Pat. No. 9,085,384, the contents of which are incorporated herein by reference in their entirety.

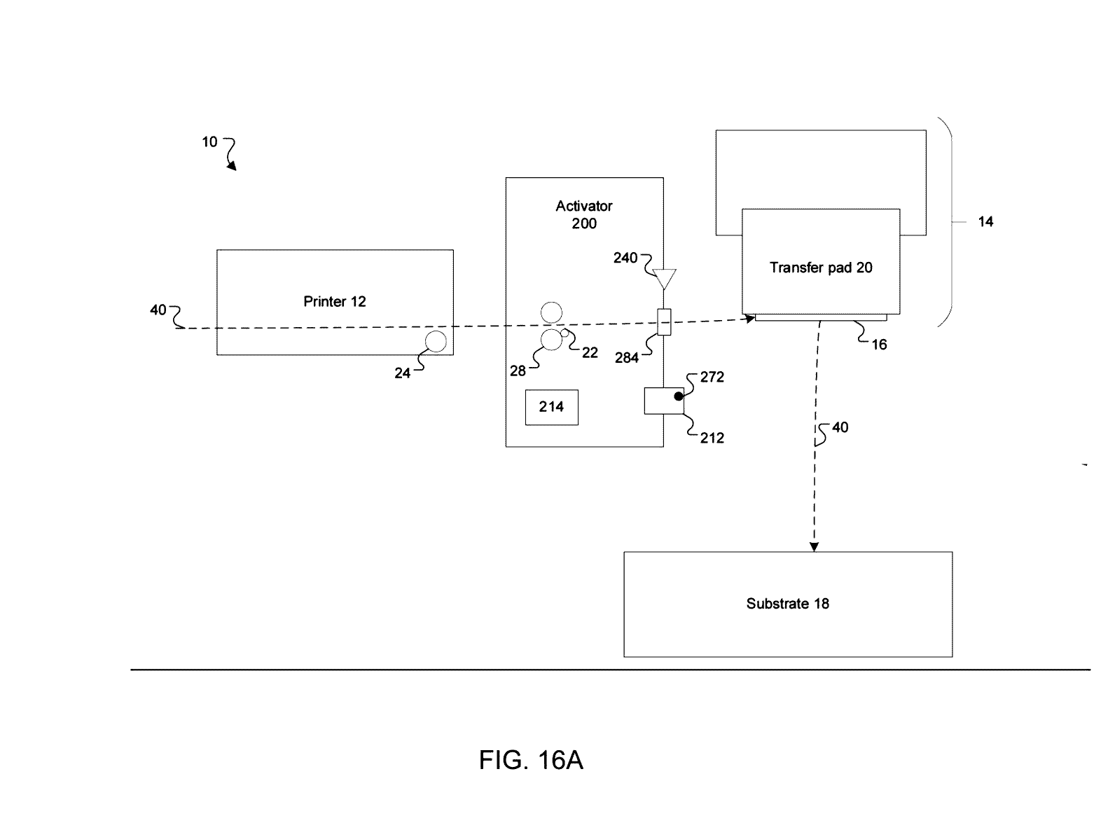

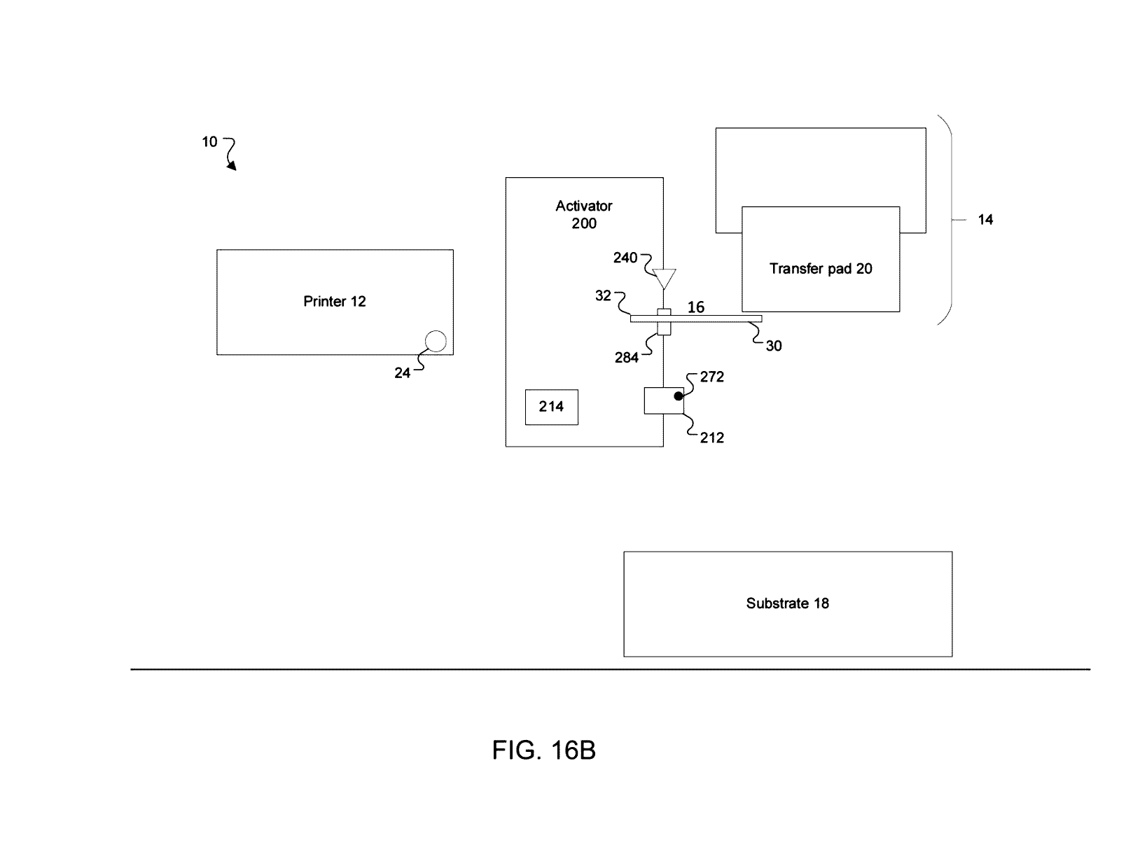

FIG. 16A shows an illustrative embodiment of a label printing and application system 10 for printing on and applying a label 16 to a substrate 18. The system includes the liner-free label activator 200 of FIGS. 4A-4E, a printer 12 upstream of the activator 200, and a label transfer device 14 downstream of the activator 200. The printer 12 can be a thermal printer, an ink jet printer, a laser printer, or another type of printer that is capable of printing an image, text, or other material on the label 16. In some examples, the printer 12 is configured to print on the top or front surface of the label 16; in some examples, the printer 12 is configured to print on both the front side and the back side of the label 16. Although FIG. 16A shows the system 10 incorporating the activator 200, other liner-free label activator embodiments can also be used in the system 10, such as other of the activators described above.

The label 16 follows a label path 40 through the system 10. The label path 40 is shown as a dashed line. Along the label path 40, the label 16 passes through the printer 12 and the activator 200, exits the activator 200 through the label slot 284, and is moved onto the bottom surface a transfer pad 20 of the label transfer device 14. In some examples, the label 16 can be secured on the transfer pad 20 by a suction applied through the transfer pad to the top side of the label 16. For example, the transfer pad 20 may include a plate or sheet made of rubber, plastic or other material that includes one or more holes through which air may be drawn. Suction created at the one or more holes may secure a label 16 to the transfer pad 20. In some examples, the label 16 can be secured on the transfer pad 20 by a reusable adhesive. In the example of FIG. 16A, the label 16 is shown secured to the bottom surface of the transfer pad 20 such that a back side of the label 16 is exposed on a side opposite the transfer pad 20.

As the label 16 exits through the label slot 284 and moves toward the transfer pad 20, fluid is sprayed onto the back side of the label from the discharge apertures 272 in the applicator 212. The fluid activates the fluid activatable adhesive on the back side of the label 16. Once the activated label 16 is secured on the transfer pad 20, the transfer pad 20 transfers the label 16 onto the substrate 18. For instance, the transfer pad 20 can move vertically downwards to press the back side of the label 16 into physical contact with the substrate 18, or may move the label 16 close to the substrate 18 and then push the label 16 toward the substrate with positive air pressure applied to the front side of the label 16. The activated adhesive on the back side of the label 16 causes the label to adhere to the substrate 18.

In some examples, the suction applied through the transfer pad 20 can assist with feeding the label 16 from the label slot 284 onto the transfer pad 20. For instance, the suction can provide a force that pulls the label 16 out of the label slot 284 and toward the transfer pad 20. In other embodiments, suction applied at the transfer pad 20 may help engage the label 16 with the transfer pad 20. For example, the label 16 may exit the slot 284 at a first location that is vertically lower than, or below, a second location where the label 16 engages the transfer pad 20. Positioning the transfer pad 20 above the location where the label 16 exits the activator 200 may help ensure that a front, or top, side of the label 16 suitably engages the transfer pad 20. As the label 16 is moved towards the transfer pad 20, e.g., in a horizontal direction, suction applied at the transfer pad 20 may draw the label 16 upwardly and into contact with the transfer pad 20.

In some examples, fluid flow, air flow, or both through the applicator discharge apertures 272 can assist with feeding the label 16 from the label slot 284 and/or assist in engaging the label 16 with the transfer pad 20 or other portion of a label transfer device 14. For instance, fluid can be sprayed from the discharge apertures 272 in a direction and at an angle that pushes the label 16 toward the transfer pad 20 or that helps keep the label 16 in contact with suction elements on the transfer pad 20 while the label 16 is being fed onto the transfer pad 20. In some examples, air flow through the discharge apertures 272 when no fluid is being sprayed, and the air can also be flowed through the discharge apertures 272 in a direction and at an angle that pushes the label 16 toward the transfer pad 20. For instance, the vertical position of the discharge apertures 272, the horizontal position of the discharge apertures 272, and/or the angle of the discharge apertures 272 relative to a vertical or horizontal direction can be adjusted to help move the label 16 relative to the activator 200 and/or feed the label 16 onto the transfer pad 20. In some examples, the discharge apertures 272 can point at an angle ranging from about 30-45 degrees off of vertical, such as about 30 degrees, about 35 degrees, about 40 degrees, about 45 degrees, or another angle. At these angles, the discharge apertures 272 apply activation fluid to the back side of the label 16, while also assisting to direct the label feed in the horizontal direction onto the transfer pad 20. The angle of the discharge apertures 272 can be set based on operating parameters of the system, such as the cone or fan shape of the activation fluid being discharged from the apertures, such that at least some of the fluid sprayed from the discharge apertures 272 is directed approximately vertically, thus helping to achieve ensure complete coverage of the back side of the label. Moreover, the direction in which discharge apertures 272 are oriented may be the same, or may be different from each other. For example, apertures 272 that discharge activation fluid may have a different orientation than apertures 272 that discharge air. Alternately, different apertures 272 that discharge activation fluid may have different orientations. Such orientations may be suitable to urge the label 16 to move in any desired way, such as horizontally to move the label 16 through and out of the activator 200 and/or vertically to move the label 16 toward a label transfer device 14.

In some examples, a first subset of the discharge apertures 272 are used for spraying fluid to activate the fluid activatable adhesive on the back side of the label 16, and a second, different subset of the discharge apertures 272 are used for spraying fluid or air or both to push the label 16 onto the transfer pad 20. The first and second subsets of the discharge apertures can be located in substantially the same position on the activator 200 or can be located in different positions. For instance, the first subset of the discharge apertures can be located in a position that is suited for spraying fluid onto the label for activation, and the second subset of the discharge apertures can be located in a position that is suited for pushing the label onto the transfer pad 20.

Referring to FIG. 16B, the cutting mechanism 240 can be used when the label printing and application system 10 is used to process uncut label stock or other media. The cutting mechanism 240 can be positioned upstream and near the activator 200, such as above the applicator 212. The applicator 212 and the cutting mechanism 240 can be shaped such that the applicator 212 can be tucked under the cutting mechanism 240 while still maintaining a position that enables spray from the discharge apertures 272 to reach the label 16. During operation, the label 16 can be partially moved past the discharge apertures 272, e.g., partially advanced out of the label slot 284, and then paused to be cut from the uncut label stock by the cutting mechanism 240. For instance, the label 16 can be advanced until at least half of the label has exited the label slot 284, such as at least 50%, at least 60%, at least 70%, at least 80%, or at least 90% of the label. FIG. 16B shows the configuration of the system 10 when the label 16 is stopped to be cut by the cutting mechanism 240. In this case, a first, leading portion 30 of the label 16 has been advanced out of the label slot 284 and a second, trailing portion 32 of the label 16 remains in the activator 200. The back side of the first, leading portion 30 has been sprayed with fluid from the discharge apertures 272, but the back side of the second, trailing portion 32 has not have fluid applied.

While the label 16 is being advanced out of the label slot 284, the applicator 212 sprays the label 16 with fluid to activate the fluid activatable adhesive on the leading portion 30 of the label that has exited the label slot 284. While the label 16 is stopped for cutting, the spray from the applicator 212 is also stopped, reducing fluid waste and preventing the leading portion 30 of the label 16 that has exited the label slot 284 from becoming excessively wet. Once the label 16 has been cut by the cutting mechanism 240, the trailing portion 32 of the label 16 is advanced out of the label slot 284 and the back side of the trailing portion 32 is sprayed with fluid from the activator 200, helping achieve complete and uniform fluid coverage across the back side of the label 16.

The two-stage application of activation fluid to the label 16 where a first leading portion 30 has fluid applied followed by a second trailing portion 32 having fluid applied to can provide advantages where two different systems are used to move the label relative to the applicator 212. That is, while a single drive system could be used to move the label 16 relative to the applicator 212 through its full range of motion needed to apply fluid to the entire or other desired section of the label, in some embodiments, the label 16 may be moved relative to the applicator 212 by two different drive system, e.g., a first label drive upstream of the applicator 212 and a second label drive downstream of the applicator 212 for fluid application. Such an arrangement may be particularly useful where a label is part of an elongated label stock (e.g., paper roll suitable to make a plurality of labels), and is cut from the label stock at a location near where activation fluid is applied to the label. However, first and second label drives may be used in other arrangements, such as where a label is not cut from label stock, but rather labels are provided to the activator as separate, individual elements. For example, a stack of individual labels may be hand-fed to an activator 200 or fed to the activator 200 by an automated feeding system. Regardless of how the labels are arranged, an upstream first label drive may move a label relative to the applicator 212 so that a first portion of the label has activation fluid applied, and then a downstream second label drive may move the label relative to the applicator 212 so that a second portion of the label has activation fluid applied. A first label drive may be arranged in different ways, e.g., may include a set of rollers, a conveyor, belt, etc. in the printer 12, in the activator 200, or other component and be located upstream of the applicator 212. A second label drive may be arranged in different ways as well, e.g., as a robotic arm or other structure, a conveyor, belt, etc. that is downstream of the applicator 212. In this illustrative embodiment, the label transfer device 14 includes a second label drive, but the second label drive may be part of the activator 200 or other component. Since the second label drive receives the label after activation fluid has been applied, the second label drive may need to engage the label in a different way than the first label drive, or be configured to accommodate the activated adhesive. In this embodiment, the label transfer device 14 engages a top or front side of the label 16 which has no adhesive. However, a roller or other drive that engages the back or bottom side of the label 16 may be used in the second label drive.

In the illustrative embodiment of FIGS. 16A and 16B, a first label drive may be included in the printer 12 and/or in the activator 200, e.g., as a set of one or more rollers, and may be arranged to move the label 16 relative to the applicator 212 so that a first, leading portion 30 of the back side of the label has fluid applied by the applicator 212. This movement may position the leading portion 30 suitably so that the label 16 can be secured to the transfer pad 20 of the label transfer device 14. Where label stock is used, the first label drive may stop movement of the label 16 so that the cutter 240 can cut the label 16 from the label stock. Alternately, the cutter 240 may move with the label 16 and cut the label from the label stock without stopping movement of the label, and after cutting, the cutter 240 may index backwards for a next cutting action. Once the label 16 is cut from the label stock, the first label drive (whether part of the printer 12 and/or activator 200) may not be able to further move the label 16 relative to the applicator 212 after a certain point, such as when the trailing end of the label disengages from the first label drive. However, since the label 16 may be secured to the label transfer device 14 at the point when the label can no longer be driven by the first label drive, the label transfer device 14 may pick up movement of the label 16 relative to the applicator 212 so that the second, trailing portion 32 of the back side of the label may have fluid applied. A similar hand-off type, or two-stage drive operation may be used with individual labels as well. In such a case, the first label drive may be able to move the individual labels just so far relative to the applicator 212, after which point the second label drive may take over and move the label to complete fluid application.

Referring again to FIG. 16A, in some examples, the operation of the applicator 212, a first label drive and/or a second label drive can depend on operating parameters of the label printing and application system 10. For instance, the volume of fluid sprayed from the applicator 212, the flow rate of the fluid sprayed from the applicator 212, the timing of spraying of fluid from the applicator 212, or other operations of the applicator 212 can depend on the speed with which the label 16 moves along the label path, whether moved by a label drive upstream and/or downstream of the applicator 212. The operation of the applicator 212 can be controlled by the activator control system 214. For instance, the activator control system 214 can receive a signal indicative of the label speed as moved by the first and/or second label drive and can control one or more of the fluid volume, the flow rate, and the timing of spraying of fluid based on the label speed.

In some examples, such as when the label 16 is moved along the label path by one or more rollers 28 that are part of the activator 200 or part of the printer 12 (described above; a first label drive), the label speed can be detected by a roller encoder unit 22 or other suitable detector. The roller encoder unit 22 in this embodiment includes a sensor that is capable of detecting the linear speed of the label 16 as the label moves along the label path 40. The roller encoder unit 22 is communicatively coupled with the activator control system 214 such that the detected speed of the label 16 can be provided to the activator control system 214, and the control system 214 can adjust one or more parameters of the applicator 212 and/or control the label transfer device 14 accordingly.

In some embodiments, a first speed of the label when moved by a first label drive relative to the applicator 212 may be used to control a second speed of the label when moved by a second label drive relative to the applicator 212. For example, the control system 214 may detect a first speed of the label 16 when moved by the printer 12 relative to the applicator 212 while the applicator 212 applies fluid to a first, leading portion 32 of the label. The first speed may be detected in different ways, such as by an encoder described above, by speed information provided by the printer 12 controller to the control system 214, by an optical sensor that detects movement of the label 16 and others. The control system 214 may use the first speed to control operation of the label transfer device 14 or other second label drive to help ensure that the applicator 212 applies a suitable amount of fluid to the back side of the label 16. For example, the control system 214 may control the label transfer device 14 to move the label 16, after the label is secured to the label transfer device 14, so that the label moves at a second speed relative to the applicator 212 that is equal to the first speed. This may allow the applicator 212 to operate with the same fluid application parameters to apply fluid to the second, trailing portion 30 of the label as was used to apply fluid to the first, leading portion of the label 16. By having the label moved at the same speed relative to the applicator 212 when applying fluid to the leading and trailing portions of the label, a consistent application of fluid can be applied to the back side of the label even though the label is moved by two different label drives for the application of fluid. Alternately, the control system 214 may control the label transfer device 14 to move the label at a second speed that is different than the first speed as the applicator 212 applies fluid to the trailing portion 30, and control the applicator 212 to adjust fluid application parameters as desired to provide a suitable fluid application to the label. For example, the label may be moved at a first speed by the upstream label drive at a rate faster than the downstream label drive can move the label. In this case, the control system may control the downstream label drive to move the label as fast as possible, but adjust fluid application parameters (e.g., increase the fluid flow rate and/or pressure) to achieve a uniform fluid application across the back of the label.

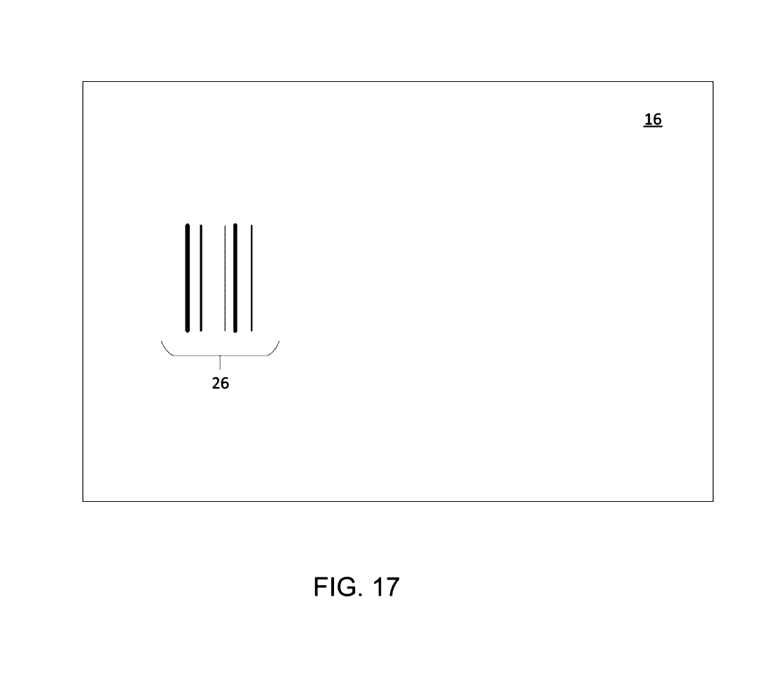

In some examples, the label speed can be detected by a non-contact sensor 24 positioned along the label path. In the example of FIG. 16A, the non-contact sensor 24 is positioned at the exit of the printer 12; however, the sensor 24 can also be positioned at other locations along the label path. In these examples, referring also to FIG. 17, a known pattern of markings 26 is printed on the back side of the label 16. For instance, the pattern of markings 26 can be multiple parallel lines having specified widths and separations. The sensor 24 detects the pattern of markings 26 as the label 16 moves past the sensor 24, and determines the label speed based on the motion of the pattern of markings 26 past the sensor. In some examples, the interaction between the sensor 24 and the pattern of markings 26 acts as a linear encoder in which the sensor 24 counts when each line in the pattern of markings 26 passes by. The label speed can then be determined based on the timing of the line movement and information about the separation between lines in the pattern of markings 26. The sensor 24 can also detect when a label has stopped moving, e.g., because of a fault condition or because a user stopped the system; and when a label restarts moving. The sensor 24 is communicatively coupled with the activator control system 214 such that the determined speed of the label 16 can be provided to the activator control system 214. The activator control system 214 can control activation spray parameters, such as the fluid flow rate through the discharge apertures 272, a volume of fluid applied to the label 16 through the discharge apertures 272, and a timing of fluid flow through the discharge apertures 272, based on the speed of the label 16.

In some examples, the non-contact sensor 24 can also be used to detect the direction of motion of the label 16, the orientation of the label, or other parameters related to the motion of the label through the system. In some examples, the pattern of markings 26 can be a non-symmetrical pattern such that the sensor 24 can distinguish between forward motion and backwards motion. In some examples, the direction of motion can be determined by two sensors (not shown) capable of sensing the relative motion of the pattern of markings 26. Sensing the direction of motion of the label 16 can be useful to assist the activator control system 214 in maintaining accurate web position information. For instance, if the web is reversed to retract a small portion of the label on the upstream side of the cutting mechanism 240 back into the printer for printing, the activator control system 214 can delay the spraying of fluid from the discharge apertures 272.

Other implementations are also within the scope of the following claims.

1. A system comprising:
an applicator including at least one aperture configured to apply fluid to a back side of a label, the back side of the label including a fluid activatable adhesive;
a speed detector configured to detect a first speed of the label along a portion of a label path of the system in which the label is attached to label stock and the applicator applies fluid to a first portion of the back side of the label;
a cutter arranged to cut the label from the label stock at a location upstream of the applicator; and
a control system configured to control a second speed at which the label is moved relative to the applicator after the label is cut from the label stock and during which the applicator applies fluid to a second portion of the back side of the label based on the first speed of the label.

2. The system of claim 1, wherein the speed detector is configured to detect the first speed of the label without physically contacting the label.

3. The system of claim 2, wherein the speed detector is configured to detect a pattern of markings on the back side of the label.

4. The system of claim 2, wherein the speed detector comprises an encoder roller.

5. The system of claim 1, further comprising a printer upstream of the cutter configured to print an image or text onto the front side of the label.

6. The system of claim 1, further comprising a label transfer device configured to receive the label from the cutter and apply the back side of the label to a substrate such that the fluid activatable adhesive adheres the label to the substrate.

7. The system of claim 6, wherein the control system is arranged to control the label transfer device to move the received label away from the applicator such that the label moves at the second speed while the applicator applies fluid to the second portion of the back side of the label.

8. The system of claim 7, wherein the control system controls the label transfer device to move in a first direction while the applicator applies fluid to the second portion of the back side of the label, and controls the label transfer device to move in a second direction different from the first direction to apply the back side of the label to the substrate.

9. The system of claim 6, wherein suction is used to secure a front side of the label to the label transfer device.

10. The system of claim 1, wherein the application of fluid to the back side of the label activates the fluid activatable adhesive, and wherein the second speed is equal to the first speed.

11. A system comprising:
a label activator including at least one aperture configured to apply a fluid to a back side of a label, the back side of the label including a fluid activatable adhesive; and
a label transfer device configured to transfer the label to a substrate, the label adhering to the substrate with the fluid activatable adhesive,
wherein the at least one aperture of the label activator is positioned such that fluid or air flow from the at least one aperture pushes the label toward the label transfer device.

12. The system of claim 11, wherein the at least one aperture of the label activator is angled relative to a vertical direction such that fluid or air flow from the at least one aperture pushes the label upwardly toward the label transfer device.

13. The system of claim 11, wherein the label is moved out of the label activator at a first location, and wherein the label transfer device includes a surface to receive the label at a second location above the first location.

14. The system of claim 13, wherein the at least one aperture of the label activator is arranged such that fluid or air flow from the aperture urges the label into contact with the surface of the label transfer device while the label is moved out of the label activator.

15. The system of claim 14, wherein the surface of the label transfer device includes a suction element arranged to secure a front side of the label to the surface.

16. The system of claim 11, further comprising a printer upstream of the label activator configured to print an image or text on a front side of the label.

17. The system of claim 11, further comprising a control system configured to:
cause the label activator to apply the fluid to a first portion of the back side of the label;
cause the label to be cut from a label stock; and
cause the label activator to apply the fluid to a second portion of the back side of the cut label.

18. The system of claim 17, wherein the control system is arranged to detect a first speed of the label while the label activator applies fluid to the first portion of the back side of the label, and is arranged to move the cut label at a second speed equal to the first speed while the label activator applies fluid to the second portion of the back side of the label.

19. The system of claim 17, wherein the label transfer device is arranged to receive the cut label from the label activator prior to the label activator applying the fluid to the second portion of the back side of the cut label, and the control system is arranged to control the label transfer device and the received label to move away from the label activator while the applicator applies fluid to the second portion of the back side of the label.

20. The system of claim 17, wherein the control system is arranged to detect a first speed of the label while the label activator applies fluid to the first portion of the back side of the label, and is arranged to control the label transfer device to move the cut label at a second speed equal to the first speed while the label activator applies fluid to the second portion of the back side of the label.

21. A system comprising:
a first label drive arranged to move a label along a path;
an applicator arranged to receive the label from the first label drive and including at least one aperture configured to apply fluid to a back side of the label, the back side of the label including a fluid activatable adhesive;
a speed detector configured to detect a first speed of the label while the first label drive moves the label and the applicator applies fluid to a first portion of the back side of the label;
a second label drive arranged to receive the label from the applicator and move the label relative to the applicator while the applicator applies fluid to a second portion of the back side of the label; and
a control system configured to control a second speed at which the label is moved relative to the applicator by the second label drive based on the first speed.

22. The system of claim 21, wherein the second speed is equal to the first speed.

23. The system of claim 21, further comprising a printer upstream of the applicator configured to print an image or text onto the front side of the label, and wherein the first label drive is part of the printer.

24. The system of claim 21, wherein the label is part of an elongated label stock while moved by the first label drive, the system further comprising a cutter arranged to cut the label from the elongated label stock at a location upstream of the applicator after the applicator has applied fluid to the first portion of the back side of the label.

25. The system of claim 21, further comprising a label transfer device configured to transfer the label to a substrate, the label adhering to the substrate with the fluid activatable adhesive, and wherein the second label drive is part of the label transfer device.
